(19) United States
(12) Patent Application Publication
(10) Pub. No.: US 2003/0199792 A1
(43) Pub. Date: Oct. 23, 2003

(54) Non-surgical methods of manipulating, facilitating and/or treating soft tissues and joints

(76) Inventor: Allan Austin, Toronto (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 09/984,956

(22) Filed: Oct. 31, 2001

(51) Int. Cl. A61H 1/00

(52) U.S. Cl. 601/1

(57) ABSTRACT

The invention relates to the field of manual treatment for assessing, diagnosing and treating dysfunction, abnormality or injury associated with soft tissues and joints.

### BACKGROUND OF THE INVENTION

1. Field of the Invention

The invention relates to the field of manual treatment for assessing, diagnosing and treating dysfunction, abnormality or injury associated with soft tissues and joints. The present invention relates to the non-surgical manual treatment, facilitation and/or manipulation of soft tissues that traverse, control and surround joints, in order to ameliorate symptoms associated with joint and/or soft tissue injury, dysfunction or abnormality, as well as to increase and/or restore soft tissue function or articular kinetics that may be adversely effected by the condition of the soft tissues and/or joints.

The present invention also relates to treating conditions that traditionally have not been associated with dysfunction, abnormality or injury associated with soft tissues and joints. The invention further relates to the non-surgical manual treatment, facilitation and/or manipulation of soft tissues to ameliorate symptoms associated with aberrant meridian function.

2. Background of the Related Art

Under optimal conditions, the muscloskeletal system of the human body is maintained in a state of balance and coordination throughout a wide range of postures and activities. Within the muscloskeletal system, the soft tissues that are associated with and control articular kinetics play an important role in maintaining this balance and coordination. Soft tissues that traverse, control and/or surround joints can include, for example, the muscles, tendons, blood vessels, fascia and nerves. Within this system of soft tissues, muscles can be a source of, and a recipient of, significant neural activity. This neural activity can include sensory as well as conscious and autonomic motor activity in relation to the control of muscle strength, muscle length, as well as muscle activity (e.g. its degree of relaxation and/or contraction). Articular kinetics of a joint can be dependent on the activity, strength, length and possible range of motion of the soft tissue that traverses, controls or surrounds that joint. As a result, the condition of the soft tissue, such as, for example, the degree of shortening, aberrant activity or weakness of a muscle, can contribute to reduced or abnormal anticular kinetics.

For example, injury or inflammation of the facia, which is the connective tissue that may surround or encapsulate other soft tissues such as muscle or nerve, can result in adhesive fibrogenesis. Adhesive fibrogenesis may result in the decrease of fascial elasticity and increased fascial tension, the resultant effect being the development of fascial tension and decreased mobility.

Injury or inflammation can also alter the anatomy and/or physiology of nerves. Fibrous adhesions, which may form as a result of repair processes following neural tissue injury, can result in changes to the structures associated with the nerve. As a result, adhesions can form anywhere along the nerve and decrease the ability of the nerve to elastically respond or move (e.g. neural glide) to or with the movement and/or contractions of associated joints, muscles or tendons.

Muscle tissue dysfunction due to injury or inflammation (i.e. myositis) can also be problematic. Examples of dysfunction of muscles can include muscle spasm, muscle contraction, muscle hypertonicity, muscle shortening, muscle weakness, muscle spasticity, muscle rigidity, etc.

Muscle spasm, also known as muscular hypertension or hypertonicity, can result from involuntary electromyographic activity. Muscle spasm can be a response by a muscle to mental, physical or emotional stresses, including, for example, nociceptive flexion reflexes. Symptoms associated with muscle spasms can include pain, tenderness, stiffness, immobilization, and abnormal or antalagic posture (i.e. posture assumed in order to avoid or lessen pain). Pain due to muscle spasm can be continuous, dull, diffuse and achy with sharp or penetrating qualities when pain is intense. Pain due to muscle spasm has been suggested to arise from the excitation of nociceptors (i.e. peripheral nervous system receptors sensitive to painful mechanical stimuli, extreme heat or cold, chemical stimuli, etc.) in the muscles, tendons and/or joint capsule. The nociceptors may be excited by mechanical strain, thermal stimuli and excessive or sustained muscle contraction. Nociceptors from several sites could then create an afferent input to a segment of the spinal cord, which may eventually result in muscle contraction due to spinal motor reflexes. This could result in a positive feedback loop, which maintains the muscle spasm and the associated pain.

Muscle contraction can also be a feature of musculoskeletal dysfunction. It has been suggested that regions where a muscle's contractile elements have been overloaded (i.e. increase neural sensitivity resulting in increase neural stimulation of the muscle fibres) may lead to damage of the sarcoplasmic reticulum, releasing excess calcium. If a region cannot remove the excess calcium, sustained contraction of the muscle fibers in that region may be induced. A “palpable band” can be produced (e.g. an area of sustained contraction of the muscle fibres). Such muscle contractions may also cause tendons to be enthesopathically thickened. Such conditions may lead to “classic contracture”, a condition where a muscle is contracted in absence of action potential.

If muscles or portions thereof are not able to relax (i.e. decease contractions to resting levels), metabolic by-products, such as lactic acid, may build up. The build up of metabolic by-products can interfere with the oxygen supply of the region, which causes a further tightening of the muscle with more metabolic by-product production, creating a vicious cycle, which may lead to muscle scarring (e.g. muscle fibrosis).

Muscle tightness or muscle shortening may co-exist with muscle spasm. Muscle tightness can be due to a proliferation of hypertrophic connective tissue. The tight muscle is shorter at rest and may not be able to be stretched, either passively or actively, to its normal length. Muscle shortening can take place through a change in the strength of the antagonistic muscle(s) relative to the agonist muscle(s). A tight or shortened muscle does not allow the full range of motion of the affected joint.

Muscle spasticity commonly refers to an involuntary muscle spasm that can be observed in conditions involving upper motor neuron lesions. Contrary to muscle spasticity, muscle rigidity can be caused by imbalance between the direct and indirect pathways of the basal ganglia, and is characterized by co-contraction of agonist and antagonist muscle(s).

It has been suggested that areas of soft tissue dysfunction can be identified through palpation of the soft tissues. Many of these palpable areas, which have been previously located and identified, include, for example, trigger points (TrP), tender points, palpable bands, etc., as described in Travell, T. G. and Simons, D. G., Myofascial Pain and Dysfunction: Trigger Points Manual (Williams and Wilkins, Baltimore, Md., 1998), the contents of which are hereby incorporated by reference. While the pathophysiology of these areas is not well understood, the anatomical and spatial location in which these areas tend to be found are similar in most individuals. Trigger points can be found in muscles, tendons, capsules and ligaments of the joints, the periosteum or the skin and have traditionally been identified as tender areas of a soft tissue that, when palpated with sufficient pressure, produce a sensation of pain or elicit an involuntarily response (traditionally referred to as a “jump sign”). Trigger points may also occur in scar tissue, but in such cases their distribution will vary from individual to individual. These areas may also be associated with an area of referred pain. Trigger points have been noted to be associated with conditions, such as, for example, myofascial pain syndrome.

Similar to trigger points, tender points have been located at multiple points on soft tissues. Tender points have traditionally been identified as points that produce pain where pressed, but do not refer pain elsewhere. Tender points and trigger points can be prevalent in mechanically stressed soft tissues as well as static load bearing soft tissues, most notably those subject to increased postural demands, such as, for example, the upper trapezius, the levator scapula, the suboccipitals, the psoas, and the quadratus lumborum. Sensitization of nociceptive and mechanoreceptor organs within such effected tissues have been suggested to have a role in mediating the formation of tender points and trigger points.

Pain is commonly, but not always, associated with injury, dysfunction or abnormality of soft tissue and joints. Myofascial pain syndrome, for example, is a pain pattern resulting from soft tissue dysfinction. The phenomenon of referred pain may result from a “facilitated segment”. A “facilitated segment” arises when increased afferent or sensory input (e.g. input from proprioceptors or nociceptors) to a segment of the spinal cord result in increased excitation of that segment. As a result of the increased excitation, the facilitated segment may produce afferent sensory output to other sensory nerves innervating that segment, causing both skeletal and/or soft tissue innervated by the affected spinal cord segment to be maintained in a state of over activity. All structures receiving efferent nerve fibers from that segment are, therefore, potentially exposed to excessive excitation or inhibition.

The facilitated segment may become a self-perpetuating source of irritation. An injury, for example, of the biceps produces an increase in neural impulses, which can be transmitted by way of the type Ia and II neurons, to the spinal segment at the level of C5. If the discharge exceeds a threshold level, other muscles connected to this segment, such as, for example, supraspinatus, teres minor, levator scapula, pectoralis minor, in the case of the bicep, may become stimulated. This results in an increase in the “gamma gain” to these muscles. Gamma gain, or increased activity of the gamma efferent nerves, results in increase basal level of contraction of the innervated muscle (i.e. increased muscle tone). As a result of this gamma gain, several muscles supplied by the same segment of the spinal cord may have an increased setting of their gamma bias (background tone fed to the muscle spindle apparatus), which can lead to increased hypertension or hypertonicity, that can, in turn, lead to increased susceptibility to muscle strain.

A functional model of the musculoskeletal system holds that biomechanical disturbances can be a manifestation of aberrant conditions of soft tissues. According to such a model, aberrant conditions of soft tissues (e.g. dysfunction, abnormality or injury thereof) may translate into reduced or abnormal articular kinetics. The aberrant condition of soft tissues can be viewed as an expression of pathological biochemical processes at structural and/or biochemical levels. Such conditions, which can be collectively referred to as somatic dysfunction, can produce symptoms, such as, for example, reduced joint play; loss of tissue resilience, tone, or elasticity; temperature and tropic changes; and loss of overt range of motion and postural asymmetry. An etiology of neuromusculoskeletal and articular conditions that can induce pain, affect articular kinetics or otherwise impact on proper tissue or joint function has been suggested to be somatic dysfunction. A functional diagnosis assesses the range of joint and muscle motion as well as the condition of soft tissues and may attempt to prescribe one or a selection of treatment modalities to correct the somatic dysfunction.

Somatic dysfunction of soft tissues and joints can lead to several disorders or conditions, the symptoms of which negatively affect the activities of afflicted patients. Such disorders can include, for example, conditions of the extremities, such as, for example, bursitis, rotator cuff tendonitis, impingement syndrome, thoracic outlet syndrome, acromioclavicular sprain, sternoclavicular sprain, post fracture conditions, frozen shoulder, tennis and golfer's elbow, carpal tunnel syndrome, plantar fasciitis, radiating arm and head pain, thoracic outlet syndrome, and sciatica, as well as, conditions of the neck, back, pelvis and thorax, such as, for example, sacroiliac, gluteal, sciatic, lumbosacral, neck, upper and lower back pain, ribs, headaches, whiplash, asthma, lumbar strain, wry neck (i,e. torticollis), general myofascial musculotendinous or musculoskeletal conditions.

Treatment protocols or modalities that employ western-based knowledge, such as, for example, application of hot and/or cold, surgery, physiotherapy as well as drug treatment, may not provide adequate relief from the symptoms associated with these disorders. For example, when a muscle is injured, its synergistic muscles can be employed to maintain function, referred to as “recruitment”. Since most western-based medical treatment and protocols for an acute or chronic muscle injury may take a long time to produce results, such as weeks or months, the body may begin to recognize the use of the employed synergistic muscle(s) as “normal.” Therefore, patients may have a return of symptoms after treatment cessation. Furthermore, western-based treatment modalities may not be in a position to adequately diagnose multiple aspects of soft tissue injury. For example, it has been suggested that symptoms that can be attributed to disk pathology, arthritis or stenosis, could be attributed to soft tissue or joint dysfunction.

In an attempt to obtain relief from soft tissue or joint problems, patients have also turned to treatment modalities based on non-western medical knowledge. These non-western medical practices have been referred to under the umbrella term as “alternative medicine”. Alternative medicine can encompasses a vast number of practices and systems of health care that, for a variety of cultural, social, economic, or scientific reasons, may not have been fully accepted by practitioners of purely western-based medicine. Alternative medicine can be derived from numerous practices such as, for example, traditional Chinese medicine, ayurveda, homeopathy, facilitation, manipulation and naturopathy.

Medical or health practitioners of alternative medicine techniques have suggested that the improvement of “energy flow” may be used to alleviate several conditions, including injury, dysfunction or abnormality associated with soft tissue and joints. U.S. Pat. No. 6,132,452 to Pinter, as well as U.S. Pat. No. 5,199,876 to Waldman, have described an “energy flow” system within and around the human body involving energy flow pathways, known as “meridians”. Meridians have described in Harris, S., Harris, J, and Yuan, J., Accuputunce Points, (Papertech, Inc. 1998, ISBN 1-55080-198-8), Jayasuriya, A, Accupuncture: The 14 Channels (16^{th} Ed., Medicina Alternativa International) and Thie, J. F., Touch for Health (Revised Ed., T. H. Enterprises, 1994), the contents of all of which are hereby incorporated by reference. Meridians have been described as a series of lines located along the human body, each line being associated with an internal organ or organ system, such as, for example, the lung, the large intestine, the stomach, the spleen, the heart and the liver. For example, the lung (LU) meridian, which extends from the tip of the right or left thumb to the right of left shoulder, has traditionally been associated with lung function. It has been suggested that symptoms associated with conditions that affect lung function can be ameliorated by employing the meridian line associated with the lung. Similarly, conditions of internal organs or organ systems may be treated by employing the corresponding meridian line.

Alternative medical techniques, such as, for example, reflexology and kinesiology, may incorporate the use of these meridians. Kinesiology, for example, applies a range of techniques to promote “energy flow” along these meridians. Other alternative treatment modalities such as techniques involving acupuncture and acupressure (e.g. the Japanese massage technique Shiatsu) have been used in an effort to alleviate disorders that arise from decrease flow along the known meridians. Acupuncture and acupressure can involve the application of needles or pressure at selected points along the meridians lines (“meridian points”) depending on the effect desired. In addition to what have been traditionally referred to as principle meridian lines, a number of additional points, also known as “extraordinary” points, have been described. Collectively referred to as “meridian points”, over 300 meridian points located on the human body have been described. Current alternative treatment modalities such as those noted above may not, however, provide quick and/or adequate relief of patient symptoms associated with injury, dysfunction or abnormality of soft tissues and joints.

It has been suggested that aspects of alternative medicine may have a correlation to aspects of western-based medical treatments. For example, the locations of anatomical structures that has been referred to as “Heine cylinders” have been suggested to correlate with the location of meridian points. Heine cylinders have been described as extracellular apparatuses that project towards the skin surface away from the fascia, which may provide a sensory function that penetrates to the skin. It has also been shown that there can be more Heine cylinders than meridian points. It is suggested that Heine cylinders that are not associated with meridian points may correlate with areas of therapeutic interest. It is desirable, therefore, to have treatment modalities that provide quick and adequate relief from disorders that result from injury, dysfunction or abnormality associated with soft tissue and joints. It is also desirable to have treatment modalities, which can ameliorate symptoms associated with a wide range of conditions.

### SUMMARY OF THE INVENTION

The present invention is directed to techniques for assessing, diagnosing and treating somatic dysfunction of soft tissues and joints. The treatment modalities of the present invention can be used to relieve soft tissue or joint injury as well as to increase soft tissue and joint performance by combining aspects of western-based medical knowledge with alternative medicine treatment modalities. Embodiments of the present invention can, for example, be beneficial to patients suffering from somatic dysfunction or individuals seeking improved entertainment and sports related performance.

The present invention is directed to pain reduction, inflammation reduction, relaxation (i.e. unloading) of muscle(s) associated with target sites, reduction of restrictions in joint range of motion, restoration of soft tissue movement, healing of soft tissue, restoration and resetting of optimal resting gamma bias (i.e. muscle tone), muscle performance enhancement (e.g. strength, length, power, speed), removal of any non-organic impediment to optimal nerve function, dissipation of soft tissue, myofascial or neuromyofascial lesions that are adhesive and/or fibrotic in nature with restoration of unimpeded soft tissue glide.

The present invention provides a technique for the non-surgical manual facilitation and/or manipulation of soft tissues that improves the rehabilitation of and the relief of localized neuromusculoskeletal and articular conditions such as chronic pain syndromes, tendonitis, sprain or strain injuries, muscle spasm and other similar conditions involving soft tissues. The treatment of the present invention can be applied during the acute phase of an injury (e.g. contemporaneously to or nearly contemporaneously to the time of injury) or as a means of therapy for sub-acute or chronic injury.

The present invention provides a technique for the non-surgical manual facilitation and/or manipulation of soft tissues that enables health practitioners to either strengthen or lengthen muscles, the benefit of which can be enhanced muscle performance, such as, for example, in the improvement of entertainment and athletic performance.

The present invention is directed to the treatment of conditions that result from, result in or contribute to musculoskeletal pain, muscle hypertonicity, acute or chronic muscle spasm, acute or chronic musculotendinous inflammation or restricted range of motion of a joint.

The present invention also provides a technique for the non-surgical manual manipulation of soft tissues so as to ameliorate symptoms associated with conditions traditionally not associated with soft tissue or articular dysfunction. These conditions can include, for example, dysfunction of the gastrointestinal tract and elimination systems, circulatory system, hepatic system, immune system, respiratory system, including, but not limited to, Addison's disease, asthma, allergies, analgesia, anaemia, angina, anorexia, anxiety, arthritis, articular rheumatism, asphyxia, autonomic imbalance, brachial neuralgia, breast disorders, chronic fatigue sydrome, cystitis, diabetes, diarrhoea, dizziness, enuresis, eyestrain, fibromyalgia, foot-drop, frigidity, gall bladder complaints, gastralgia, hangover, hardness of hearing, headache, heart disease, heaviness in the head, hemiplegia, hemorrhoids, hernia, high blood pressure, hypertension, homeostasis, illiocecal valve, indigestion, insomnia, kidney problems, lateral epicondylitis, low blood pressure, bone marrow, mental illnesses, nausea, palpitations parkinsonism, pelvic disorders, rheumatism, sinusitis, stroke, tinnitus, tonsillitis, torticollis, TOS Syndrome, and urine retention.

The present invention further provides a method of teaching the non-surgical manual manipulation methods to patients as well as medical or health practitioners.

### BRIEF DESCRIPTION OF THE DRAWINGS

The present invention and its advantages are understood by referring to FIGS. 1 to 50 of the drawings.

FIG. 1 is an anatomical drawing of the coracobrachialitis, having application points provided therein.

FIGS. 2 and 3 are photographs of depictions of a soft tissue manual manipulation techniques conducted on the coracobrachialitis.

FIG. 3 is a photograph of a depiction of a soft tissue manual manipulation technique conducted on the coracobrachialitis.

FIG. 4 is an anatomical drawing of the triceps, having application points provided therein.

FIGS. 5 and 6 are photographs of depictions of a soft tissue manual manipulation techniques conducted on the triceps. FIG. 7 is an anatomical drawing of the common flexor tendon, having application points provided therein.

FIGS. 8 and 9 are photographs of depictions of a soft tissue manual manipulation techniques conducted on the common flexor tendon.

FIG. 10 is an anatomical drawing of the psoas, having application points provided therein.

FIGS. 11 and 12 are photographs of depictions of soft tissue manual manipulation techniques conducted on the psoas.

FIG. 13 is an anatomical drawing of the adductors, having application points provided therein.

FIGS. 14 and 15 are photographs of depictions of soft tissue manual manipulation techniques conducted on the adductors.

FIG. 16 is an anatomical drawing of the hamstrings, having application points provided therein.

FIGS. 17 and 18 are photographs of depictions of soft tissue manual manipulation techniques conducted on the hamstrings.

FIG. 19 is an anatomical drawing of the lateral pterygoid, having application points provided therein.

FIG. 20 is a photograph of a depiction of a soft tissue manual manipulation technique conducted on the lateral pterygoid,

FIG. 21 is an anatomical drawing of the temporalis, having application points provided therein.

FIG. 22 is a photograph of a depiction of a soft tissue manual manipulation technique conducted on the temporalis.

FIG. 23 is an anatomical drawing of the scalenes, having application points provided therein.

FIGS. 24 and 25 are photographs of depictions of soft tissue manual manipulation techniques conducted on the scalenes.

FIG. 26 is an anatomical drawing of the splenius capitis, having application points provided therein.

FIGS. 27 and 28 are photographs of depictions of soft tissue manual manipulation techniques conducted on the splenius capitis.

FIG. 29 is an anatomical drawing of the sternocleidomastoid, having application points provided therein.

FIGS. 30 and 31 are photographs of depictions of soft tissue manual manipulation techniques conducted on the sternocleidomastoid.

FIG. 32 is an anatomical drawing of the pectoralis major, having application points provided therein.

FIGS. 33 and 34 are photographs of depictions of soft tissue manual manipulation techniques conducted on the pectoralis major.

FIG. 35 is an anatomical drawing of the intercostals, having application points provided therein.

FIGS. 36 and 37 are photographs of depictions of soft tissue manual manipulation techniques conducted on the intercostals.

FIG. 38 is an anatomical drawing of the diaphram and rectus abdominus, having application points provided therein.

FIG. 39 is a photograph of a depiction of soft tissue manual manipulation technique conducted on the diaphram and rectus abdominus.

FIG. 40 is an anatomical drawing of the upper trapezius, having application points provided therein.

FIGS. 41 and 42 are photographs of depictions of soft tissue manual manipulation techniques conducted on the upper trapezius.

FIG. 43 is an anatomical drawing of the sacrospinalis, having application points provided therein,

FIGS. 44 and 45 are photographs of depictions of soft tissue manual manipulation techniques conducted on the sarcospinalis.

FIG. 46 is an anatomical drawing of the quadratus lumborum, having application points provided therein.

FIGS. 47 and 48 are photographs of depictions of soft tissue manual manipulation techniques conducted on the quadratus lumborum.

FIG. 49 is an embodiment of the present invention.

FIG. 50 is an embodiment of the present invention.

### DESCRIPTION OF THE PREFERRED EMBODIMENT

Embodiments of the present invention are directed to the combination of aspects of both western-based medical knowledge and aspects of alternative medicine to provide patients with functional assessment and diagnostic protocols of somatic dysfunction as well as treatment protocols or modalities that ameliorate symptoms associated with somatic dysfunction of the soft tissues and/or joints of the target site(s). These embodiments may involve combining neuromuscloskeletal aspects of western-based medical knowledge with the meridian-based system provided in alternative medicine. By directing functional assessment and diagnosis protocols as well as treatment modalities to incorporate and address both the neuromuscloskeletal and the alternative medicine basis of somatic dysfunction, quick and effective treatment modalities of the symptoms associated with soft tissue and joint related conditions, as well as conditions that typically have not been associated with soft tissues and joints, have been developed.

Known and conventional treatment protocols generally involve patient assessment and diagnosis procedures, followed by patient treatment protocols. The assessment and diagnosis protocols or procedures are typically conducted by the medical or health practitioner before a treatment protocol is selected. Assessment and diagnosis protocols or procedures generally include first assessing the patient to be treated by way of, for example, obtaining the medical or personal history of the patient and conducting an evaluation of the patient by way of some type of examination (“assessment protocols”). The patient's history can be taken to determine what symptoms the patient has experienced and for how long, what treatments have been applied, and what has been the effect of those treatments. In the evaluation stage, the patient may be subjected to some form(s) of testing that may confirm or identify symptoms or conditions.

Following the assessment protocols, the medical or health practitioner can arrive at a diagnosis of the patient to be treated by way of reference to training of the medical or health practitioner, reference to some form of expert system or reference to standardized texts (“diagnosis protocols”). A diagnosis can be made based upon the results of the assessment protocols. Following the diagnosis protocols, a treatment protocol can be selected.

1. Assessment Protocols

In general, assessment procedures can involve a first step of observing and documenting areas of dysfunction, such as, for example, hypertonicity, swelling, hypertrophy and atrophy in the case of soft tissue or articular dysfunction. The health practitioner should also observe and document discrepancies between any soft tissues of the patient's right and left sides. Additional steps are to identify and/or select application points, as well as to test all involved articular areas for range of motion, and compare right and left sides. The health practitioner should also document loss of range of motion in relevant anatomical area(s). Certain range of motion procedures will also enable the health practitioner to simultaneously test for diminished muscle strength or length.

A selection of convention assessment, diagnosis and treatment protocols have been previously identified by the acronym “S.O.A.P.” for the subjective, objective, assessment and treatment plan components provided therein. The subjective component involves the patient identifying the problem area or otherwise indicating the patient's complaint. This can incorporate history of the complaint or problem area, the patient's and/or the patient's family medical history, system review and social history of the patient.

The objective component can include quantifiable results derived from the examination of sites of somatic dysfunction, such as, for example, any affected soft tissues or joints, as well as the examination of the functioning of organs or organ systems or the functioning of meridian(s) associated with internal organs or organ systems, all of which can be referred to as “target sites”. The quantifiable results derived from the examination of the target site(s) can include, for example, vital signs (i.e. pulse rate, blood pressure, etc.), physical examination findings (i.e. muscle strength, muscle length, joint mobility, etc.) and diagnostic test results (i.e. x-ray, CAT scan, chemical assays, etc.).

Before conducting any treatment modalities in accordance with embodiments of the present invention, it is preferred that a medical or health practitioner conduct a functional assessment protocol. An embodiment of the present invention involves a functional assessment protocol of the target site(s), the results of which can be used in the diagnosis protocol(s) to determine a treatment protocol. Assessment protocols of the present invention can comprise, either alone or in combination, the examination of muscle strength and muscle length at the target site(s) or the function of the meridian line(s) associated with the target site(s). A further assessment protocol of the present invention can involve the identification and/or selection of treatment application points, also known as “myopoints”.

Conventional tests can be used to examine patient muscle strength. These can include the standardized muscle strength testing protocols as described in Kendall, H. O., Kendall, F. P. and Wadsworth, G. E., Muscles: Testing and Function (2^{nd} ed. The Williams and Wilkins Company, 1971), the contents of which are hereby incorporated by reference, as well as applied kinesiology protocols as described in Thie, supra. Conventional flexibility tests can be used to examine muscle length. Finally, the “pulse reading” protocol as described in Thie can be used to examine the unction of the meridian line(s) associated with the target site(s).

(i) Muscle Strength Assessment

In assessing muscle strength, a health practitioner can use either the standardized muscle strength testing protocols of Kendall et al., supra, the applied kinesiology testing protocols of Thie, or both, to compare the relative muscle strengths of the same muscle(s) on the left and right sides of the patient, preferably the muscle(s) associated with the target site(s). If, for example, a muscle on the right side is identified as weak relative to the identical muscle on the left side, through the use of either of the standardized or applied kinesiology testing protocols, then the health practitioner has identified a muscle that may require strengthening. The health practitioner can, if indicated from the result of the diagnosis protocol, include in the treatment protocol, procedures directed to strengthening the identified muscle(s).

(ii) Muscle Length Assessment

In assessing muscle length, a health practitioner can use conventional flexibility tests to compare the relative muscle lengths of the same muscle(s) on the left and right sides of the patient, preferably the muscle(s) associated with the target site(s). If, for example, a muscle on the right side is identified as shortened relative to the identical muscle on the left side, then the health practitioner has identified a muscle that may require lengthening. The health practitioner can, if indicated in the diagnosis protocol, include in the treatment protocol, a protocol directed to lengthening the identified muscle(s).

It is also possible that a health practitioner need not conduct a strength or length assessment protocol to identify target site(s), which may require strengthening and lengthening. In the case of athletes or entertainers, specific soft tissues may be identified as requiring strengthening or lengthening without the use of an assessment. Instead, based on the performance enhancement sought, soft tissues may be selected on the basis of function.

(iii) Meridian Function Assessment

Meridian function, such as, for example, increased or decreased “energy flow” along a meridian(s), can also be assessed through the use of the pulse reading assessment protocol described in Thie. By assessing meridian function through the use of pulse reading, the health practitioner can determine whether there is an increase or decrease in “energy flow” in the meridian(s). If there is an abnormality in meridian function, such as the meridian having increased “energy flow”, the health practitioner has identified a meridian(s) that requires normalizing. After assessing meridian function by way of the pulse reading assessment protocol, the health practitioner may identify that one or more meridians, such as, for example, the Stomach (ST) meridian, may not be functioning properly, which can be referred to as being “over energized”. The health practitioner can, if indicated from the result of the diagnosis protocol, include in the treatment protocol, a protocol directed at normalizing the function of the meridian.

An embodiment of the present invention also comprises an assessment protocol that can involve the identification and/or selection of one of more areas or points on the patient's body at which treatment can be applied, referred to as “application points”, also referred to as “myopoints”. The use of the term myopoint, while suggesting that the tissue location of the application point is on or near muscle tissue, can encompass application points that can be located on soft tissue in addition to muscle, such as, for example, nerve, tendon or fascia.

The identification and/or selection of a single application point or of a set of application points can be based on either the known correlation between meridians, meridian points and the target site(s) or the manual examination of the target site(s). Embodiments of the present invention can comprise selecting application points on the basis of each of these processes of application point identification and/or selection, either alone or in combination.

In one embodiment, the identification and/or selection of a single application point or of a set of application points can be based on the known correlation between meridians, meridian points and the target site(s). It has been suggested that meridians and meridian points can be associated with target sites both proximal and distal, relative to the meridian or meridian point. Target sites proximal to a meridian or a meridian point are those target sites that are on or near the meridian or meridian point. Target sites distal to the meridian or meridian point are those target sites that are, not located on or near the meridian point. The results of assessing the target site could suggest to a health practitioner that known meridian(s) or meridian point(s) can be selected on the basis of the proximal and/or distal effects of treatment using the meridian(s) or meridian point(s).

The identification and/or selection of a meridian point by the health practitioner should be based on the effects of stimulating (e.g. applying pressure) that meridian point(s) on the target site(s), the target site(s) being either proximal or distal to the, meridian point(s). The stimulation of a meridian point has been described as having effects on: (i) conditions occurring along the corresponding meridian; (ii) conditions of the internal organ associated with that meridian, which can be distal relative to the meridian point; (iii) conditions of related tissues as previously described; and (iv) conditions of the area proximal to the meridian point. In a preferred embodiment, the meridian point can be selected on the basis of symptoms of the area proximal to the meridian point.

For example, it has been described in Jayasuriya, supra, Harris supra, and Thie, that the meridian point Lung 7 (Lu7) can be selected if the patient's presented symptoms include arthritis of the wrist, as stimulation of this meridian point results in effects at the proximal target site of the wrist. However, Lu7 could also be selected by a health practitioner if the patient's presented symptoms include bronchial asthma as well as disorders of the skin and large intestine, as stimulation of this meridian point or other points along the Lung (LU) meridian can also produce positive effects at these distal target sites.

A health practitioner may also identify and/or select application points on the basis of known trigger points and tender points as described in Travell and Simons, supra. As with the identification and/or selection of application points based on meridian points, the identification and/or selection of trigger points and tender points would be based the distal and proximal effects of stimulation of the selected trigger point or tender point.

While application points may be selected on the basis of known meridian, trigger or tender points, the selection of application points can also be conducted on the basis of the location of an area identified by palpation or an area identified by the presence of anatomically structures, such as, for example, Heine cylinders. In an embodiment of the present invention, an application point can be identified and/or selected on the basis of manual palpation by the health practitioner of the target site (e.g. palpation of a muscle). Palpation of the target site by the health practitioner can reveal points or areas of hypertonicity, hypersensitivity and fibrosis. Hypertonic application points are areas of increased muscle tone (i.e. increase gamma bias). Hypersensitive application points may arise in any tissue, such as, for example muscle, fascia, periosteum, and bone. Hypersensitive application points can be used as a confirmation of the location of lesions. Fibrosis is a condition in which fibrous material (i.e. collagen) is pathologically deposited in tissues. Soft tissue may be found on palpation to be fibrotic. Other application points can include palpable bands. fibrocytic points, adhesions, neurolymphatic points, neurovascular points, etc. that were previously unmapped.

When identifying an application point by palpation, it is preferable that pressure exerted manually by the health practitioner on the palpated area be sufficient to identify the hypertonic, hypersensitive or fibrotic application points. If the exerted pressure is too light, however, the health practitioner may be unable to palpate these application points and, as such, application points may be missed. The pressure exerted manually by the health practitioner should not, however, be so hard that tenderness on all the application points is elicited. It is preferable that the health practitioner identify one application point on or near the target site and then determine the degree of pressure required to elicit a “jump sign”. The jump sign is characterized by patient responses, such as, for example, a sudden jerking motion, grabbing of the health practitioner's hand, a fascial grimace, or the expression of a vocal expletive. The manual pressure is preferably less than the pressure required to elicit a jump sign.

In addition to hypertonic, hypersensitive and fibrotic areas, there can be anatomical structures that may be identified upon palpation, such as lesions, Heine cylinders or reflex centres. The locations of certain reflexes within soft tissues have been suggested to be associated with the functioning of the lymphatic system. Stimulation of these areas has been suggested to result in improved circulation and lymphatic drainage of target sites. These reflexive areas have been described as gangliform contractions within the deep fascia of a muscle. Health practitioners can identify these gangliform contractions upon palpation of chronically contracted muscles. As such, application points may also include areas of gangliform contraction reflexes.

In some cases, application points may be in an anatomically region distal to the target site(s), such as, for example, in the case of injury that can result from a motor vehicle accident. Such application points can be included in the treatment protocols.

Following treatment protocols, it is preferable that the medical or health practitioner inquires with the patient as to whether there is any improvement. The subjective improvement should be documented. If the patient comments that there is still a remaining area of considerable discomfort, the health practitioner can reassess and apply an additional treatment protocol. Following treatment, areas of perceived pain may migrate leading to secondary areas of pain becoming primary. If the patient comments that there is a new area of primary discomfort, the health practitioner can treat the secondary pain area according to a further assessment.

2. Diagnostic Protocols

Following assessment protocols, the health practitioner can arrive at a diagnosis of the patient's condition on the basis of the muscle(s) strength or length, meridian function or the presence of application points.

The present invention is directed to diagnosing conditions of muscloskeletal function. If a muscle(s) has been identified as being weak during assessment, the health practitioner may diagnose that the muscle(s) requires strengthening and, as such, a strengthening treatment protocol would be indicated. Similarly, if a muscle(s) has (have) been identified as being shortened during assessment, the health practitioner may diagnosis that the muscle(s) require(s) lengthening and, as such, a lengthening treatment protocol would be indicated.

The invention may also involve the health practitioner diagnosing required muscle strengthening and/or lengthening without assessing muscle strength or length. In other words, a health practitioner may not assess muscular strength or length prior to a diagnosis that a muscle of set of muscles should be strengthened or lengthened. For example, a patient may require that muscles be strengthened or lengthened, such as, for example, to improve entertainment and athletic performance. In such cases, the health practitioner may diagnose that muscle strengthening and/or lengthening would be indicated, without conducting an assessment and, as such, a strengthening and/or lengthening treatment protocol would be indicated.

The present invention further provides for diagnosing conditions that can be related to meridian function. If a meridian(s) has been identified as having increased or decreased “energy flow”, the health practitioner may diagnose that the meridian(s) require(s) normalization of the “energy flow”. For example, a patient may have an increased “energy flow” along the Stomach meridian (ST). As a result, the health practitioner may diagnose problems associated with the patient's stomach and, as such, a treatment protocol that normalizes “energy flow” along the ST meridian would be indicated.

In an alternative embodiment, a health practitioner may diagnose a condition that may require modification of meridian function, without first assessing meridian function. If a condition has been identified during an assessment without assessing the meridian function, the health practitioner may diagnose that the meridian(s), which has (have) been described as being associated with such a condition, require(s) modification of their function. For example, if a patient has identified to the health care practitioner conditions associated with organ(s) or organ system(s), the health practitioner may diagnose that the meridian(s) associated with the organ(s) or organ system(s) require(s) normalization of its function, without assessing meridian function. The diagnosed condition, however, may not be associated with any organ or organ system. These conditions, such as, for example, allergies, may also be diagnosed by the health practitioner on the basis that normalization of the function of a meridian associated with the organ(s) or organ system(s) is required without examining meridian function. Such conditions may also relate to improved performance.

3. Treatment Protocols

The present invention also involves treatment protocols by which the medical or health practitioner can manually manipulate, facilitate and/or treat the soft tissue associated with target site(s) based on the results of the assessment and diagnostic protocols. The invention can involve treatment of soft tissue associated with target site(s) through the use of neuromuscular techniques of manipulation and facilitation. The treatment protocols of the invention involve techniques of muscle lengthening, muscle strengthening and normalizing and/or stimulating meridian function.

Preferred protocols can include, for example, treatment protocols that can reduce pain, reduce muscle hypertonicity and aid the resetting of resting tonicity (i.e. gamma bias) of muscle(s), reduce soft tissue tension and restore or improve articular kinetics. Preferred protocols can also include treatment protocols that can assist in normalizing meridian function and conditions that have been suggested to be associated with abnormal or aberrant meridian function.

The treatment protocols or modalities of the present invention can be used to treat many muscloskeletal conditions of the spine, pelvis and extremities (e.g. arms, legs, etc.), including, for example, sacroiliac, gluteal, sciatic, lumbosacral, neck, upper and lower back pain, ribs, headaches, whiplash, asthma, lumbar strain, wry neck (torticollis), general myofascial or musculotendinous conditions. The treatment modalities of the invention may also be used to treat conditions such as herniated disks, facet impingement, stenosis, fusion, spondylolisthesis, degenerative disk disease, arthritis, scoliosis, healed fracture, post surgical laminectomy, post surgical diskectomy, Harrington rods, degenerative arthritis of the joints, rehabilitation of fractures, post-surgical joint replacements, bursitis, rotator cuff tendonitis, impingement syndrome, thoracic outlet syndrome, acromioclavicular sprain, sternoclavicular sprain, post fracture conditions, frozen shoulder, tennis and golfer's elbow, carpal tunnel syndrome, plantar fasciitis, radiating arm and head pain, thoracic outlet syndrome, leg pain from sciatica, ITB Syndrome, hip pointer, jumper's knee, archilles tendinitis and trigger fingers.

Many symptoms of conditions that traditionally have not been viewed as associated with muscloskeletal conditions can also be ameliorated with the treatment protocols of the present invention, including, for example, the symptoms associated with Addison's Disease, asthma, allergies, analgesia, anaemia, angina, anorexia, anxiety, arthritis, articular rheumatism, asphyxia, autonomic imbalance, brachial neuralgia, breast disorders, chronic fatigue sydrome, cancer, cystitis, diabetes, diarrhoea, dizziness, enuresis, eyestrain, fibromyalgia, foot-drop, frigidity, gall bladder complaints, gastralgia, hangover, hardness of hearing, headache, heart disease, heaviness in the head, hemiplegia, hemorrhoids, hernia, high blood pressure, hypertension, homeostasis, illiocecal valve, indigestion, insomnia, kidney problems, lateral epicondylitis, low blood pressure, bone marrow, mental illnesses, nausea, osteoporosis, palpitations, parkinsonism, pelvic disorders, rheumatism, sinusitis, stroke, tinnitus, tonsillitis, torticollis, TOS Syndrome, stress or anxiety related conditions, headaches, tinnitus, dizziness, TMJ dysfunctions, heart arrhythmia, high blood pressure and urine retention. Examples of soft tissue to be treated to ameliorate several of the conditions noted above according to aspects of the present invention is provided in Table 1.

TABLE 1

| | Soft Tissue to be Treated by Strengthening |
|---|---|
| Conditions | or Lengthening procedures |
| Absorption | Rectus Femoris |
| Addison's Disease | Sartorius, Soleus, Infraspinatus, Teres Minor |
| Ailments of the Liver | Vastus Medialis |
| Allergy | Coracobrachialis, Anterior Deltoid |
| Analgesia | Adductor Pollicis (Hoku) |
| Anaemia | Latissimus Dorsi, Vastus Medialis, Fibularis |
| Angina | Common Flexor Tendon, Flexor Carpi |
| | Radialis, Flexor Digitorum Brevis, Diaphragm |
| | Release |
| Anorexia | Brachioradialis, Tibialis Posterior, Flexor |
| | Digitorum Brevis and Hallucis Longus |
| Anxicty | Tibialis Posterior, Flexor Digitorum Brevis |
| | and Hallucis, Diaphragm Release, Flexor |
| | Carpi Radialis, Flexors of the Fingers |
| Arthritis | Spine - Paraspinal, Erector Spinae |
| Articular Rheumatism | Fibularis, Tibialis Anterior and Biceps |
| Asphyxia | Brachioradialis |
| Autonomic Imbalance | Middle/Lower Trapczius, Latissimus Dorsi |
| Blood Diseases | Bicipital Tendon, Fibularis |
| Brachial Neuralgia | Brachioradialis, Fibularis |
| Breast Disorders | Vastus Lateralis |
| Bronchial Asthma | Pectoralis Major/Minor, Intercostals, |
| | Diaphragm |
| | Release, Brachioradialis, Upper and Lower |
| | Costotransverse Junction |
| Carpal Tunnel | Common Flexor Tendon, Flexor Carpi |
| | Radialis Syndrome |
| Chronic Fatigue | Lateral Gastrocnemius, Medial |
| | Gastrocnemius, Tibialis Anterior, Tibialis |
| | Posterior, Scalenus Med. |
| Climacteric Upsets | Adductor Pollicis (Hoku) |
| Constipation | Hamstrings, Adductor Pollicis, Lower Erector |
| | Spinae, Quadratus Lumborum |
| Cystitis | Psoas, Adductors II |
| Diabetes | Latissimus Dorsi, Triceps |
| Diarrhoea | Hamstrings, Adductor Pollicis, Tibialis |
| | Posterior, Quadratus Plantae, Lower Erector |
| | Spinae |
| Dizziness | Adductor Pollicis (Hoku), Fibular is Tendon, |
| | Tibialis Posterior |
| Dysthyroidea/Thyroid | Flexor Carpi Radialis, Adductor Pollicis |
| Gland | (Hoku) |
| Enuresis | Gluteus Max, Adductors II, Lower Erector |
| | Spinae, Sacrum |
| Eyestrain | Fibularis Tendon, TMJ |
| Fibromyalgia | Lateral Gastrocnemius, Medial |
| | Gastrocnemius, Tibialis Anterior, Tibialis |
| | Posterior, Scalenus Med. |
| Foot-drop | Vastus Lateralis, Tibialis Anterior |
| Frigidity | Gluteus Med., Rectus Abdominis, Sacrum |
| Frozen Shoulder | Coracobrachialis |
| Gallbladder Complaints | Levator Scapula, Rhomboids |
| Gastralgia | Vastus Lateralis, Tender Points - Flexor |
| | Hallucis Longus |
| Golfer's Elbow | Common Flexor Tendon (Modial |
| | Epicondylitis) |
| Hangover | Extensors of the Fingers |
| Hardness of Hearing | TMJ, Temporalis |
| Headache | Brachioradialis, Iliotibial Bands, Tibialis |
| | Posterior, Flexor Digitorum Brevis, |
| | Temporalis |
| Heart Disease | Subscapularis, Flexor Carpi Radialis, Flexor |
| | Carpi Ulnaris, Tibialis Posterior |
| Heaviness in the Head | Flexor Carpi Ulnaris, Adductor Pollicis |
| | (Hoku) |
| Hemiplegia | Adductor Pollicis (Hoku) |
| Hemorrhoids | Ischial Attachment |
| Hemia | Lumbar Gluteus Med., Intervertebral Discs |
| High Blood Pressure/ | Flexor Digitorum/Hallucis |
| Hypertension | |
| Homeostasis | Extensor Carpi Radialis Longus/Brevis, |
| | Tibialis, Anterior, Lower Erector Spinae |
| Hypertrophy of the | Gluteus Med, Adductors II |
| Prostate Gland | |
| Illiocecal Valve | Psoas |
| Indigestion | Rectus Femoris |
| Insomnia | Tibialis Posterior, Suboccipitals, Atlanto- |
| | Occipital Extensors, Posterior Paraspinal |
| | Cervical Stretch |
| Immunity | Brachioradialis |
| Kidney Complaints | Tibialis Posterior, Flexor Digitorum Brevis, |
| | Multifidus, Quadratus Lumborum |
| Lateral Epicondylitis | Brachioradialis Triceps |
| Liver Ailments | Bicipital Tendon, Intercostals, Rhomboids |
| Low Blood Pressure | Scalenes, Atlanto-Occipital Extensors |
| Lung Ailment | Biceps, Quadratus Plantae |
| Male and Female | Psoas, External Rotators of the Hip, Vastus, |
| Problems | Lateralis, Tibialis Posterior, Quadratus |
| | Plantae, Sacrum |
| Marrow | Fibularis, Adductors |
| Mid-Back Pain | Carpal Bone and Wrist Extensors |
| Mental Diseases | Lateral Gastrocnemius, Medial |
| | Gastrocnemius, Fibularis Tendon, Tibialis |
| | Posterior, Flexor Digitorum Brevis and |
| | Hallucis Longus, Lower Erector Spinae |
| Nausea | Supraspinatus, Brachioradialis, Vastus |
| | Lateralis, Scalenes |
| Palpitations | Bicipital Tendon, Common Flexor Tendon, |
| | Flexor Carpi Radialis, Tibialis Posterior |
| Parkinsonism | Common Flexor Tendon, Fibularis Tendon |
| Pelvic Disorders | Gluteus |
| Plantar Fasciitis | Quadratus Plantae, Flexor Digitorum Brevis |
| Reflexology | Extensor Digitorum, Tibialis Posterior, |
| | Quadratus Plantae |
| Rheumatism | Lliotibial Band, Temporalis |
| Sciatica/Piriformis | Lower Erector Spinac, Multifidus, QL, |
| | Hamstrings, Gluteals, Gastrocs |
| Sensory Organs | Adductor Pollicis (Hoku) |
| SI Joint Dysfunction | See Male and Female Problems, Adductor |
| | Pollicis (Hoku) |
| Sinusitis | Adductor Pollicis (Hoku) |
| Stage Fright | Tibialis Posterior, Flexor Digitorum Brevis |
| | and Hallucis Longus,Diaphragm Release |
| Stimulation | Lumbricals and Interphalangcal Joints |
| Stroke | Deltoid |
| Tinnitus | Splenius Capitis |
| Tonsillitis | Tibialis Posterior, Quadratus Plantac, |
| | Scalenus Med |
| Torticollis | Sternocleidomastoid and Stretch, Posterior |
| | Paraspinal Cervicals, Atlanto-Occipital |
| | Extensors |
| TOS Syndrome | Levator Scapula and Upper and Mid |
| | Trapezius, Pectoralis Major |
| Upset Stomach | Supraspinatus, Brachioradialis, Vastus |
| | Lateralis, Scalenes, Levator Scapula |
| Urine Retention | Flexor Digitorum Brevis and Hallucis Longus, |
| | Adductors II |
| Whiplash | Atlanto-Occipital Extensor, Posterior |
| | Paraspinal Cervicals |

Each of the treatment protocols of the present invention can involve manual manipulation, facilitation and/or treatment of soft tissue and/or articular components through the simultaneous application of aspects of neurophysiology, stimulation (i.e. pressure application) of application point and patient directed techniques. The simultaneous use of the treatment modalities or methodologies of the invention provides a synergistic effect that can reduce the effects of somatic dysfunction of soft tissues and joints as well as the normalization or stimulation of meridian function.

A preferred embodiment of the present invention comprises the simultaneous application of (i) reflexogenic neurophysiology that serves to lengthen or strengthen the target muscle; (ii) stimulation of application points; and (iii) patient directed relaxation techniques. In addition, the treatment protocols of the invention can be conducted by a medical or health practitioner. The treatment protocols of the invention can also be taught to a patient so that the patient can conduct the treatment protocols at any time without the presence of a medical or health practitioner.

The present invention involves teaching the assessment, diagnosis and treatment protocols to patients and/or medical or health practitioners.

A. Reflexogenic Neurophysiology

The application of reflexogenic neurophysiology can be incorporated to improve target muscle strength or length by inducing relaxation of a target muscle through the use of known neurophysiologic reflexes. A preferred embodiment can include the use of reciprocal inhibition (RI) and the inverse myotatic reflex (IMR) as the neurophysiologic reflexes. A less commonly used embodiment involves the use of crossover reciprocal innervation reflexes or neural mechanisms between limbs, which are especially elicited during locomotion. For example, approximately 0.2 to 0.5 second after a stimulus elicits a flexor reflex in one limb, the opposite limb begins to extend. This is called the crossed extensor reflex. In this senecio, contraction of the hip flexors of the right leg would cause reflexogenic contraction of the opposite (left) leg extensors which, in turn would cause reciprocal inhibition of the flexors of the left leg. In this embodiment, the target muscle would be the muscle of the opposite limb to the one, which is being contracted. In one embodiment, the relaxation of a muscle, or an area of a muscle, associated with the target site can be induced through the resistance of the controlled contraction of the muscle associated with the target site (i.e. the agonist) or the muscle(s) of opposite action to the muscle associated with the target site (i.e. the antagonist). “Agonists” have traditionally been referred to as the muscles that cause a movement to occur. Agonists, also known as “prime movers”, create the normal range of movement in a joint by contracting. On the other hand, antagonists have traditionally been referred to as the muscles that act in opposition to the movement generated by the agonists. Antagonists, for example, are responsible for returning a limb to its initial position. In the description, the term “antagonist” refers to the muscles that move in opposition to the target muscles, which may be referred to as the agonists. It is possible that some muscles, which have been traditionally described as agonists, may be described as antagonists within the specification.

In a preferred aspect of the present invention, the resistance to the controlled contraction of the agonist target muscle or its antagonist can be applied by the medical or health practitioner. However, the resistance to the controlled contraction of the agonist target muscle or its antagonist can also be applied by the patient through the use of stationary objects, such as, for example furniture. Depending on which neurophysiologic reflex is employed, the muscle(s) of the target site can be either lengthened or strengthened.

(i) The Strengthening Procedure

Reciprocal Inhibition (RI) is one of the known neurophysiologic reflexes that allow for coordinated muscle action. Reciprocal inhibition is a reflex in which the contraction of a muscle is associated with the relaxation of a second, opposing muscle. For example, if a target muscle (i.e. the agonist muscle) is hypertonic, contraction of the muscle in opposition to the hypertonic target muscle (i.e. the antagonist muscle) can lead to a reduction in the hypertonicity of the agonist, thereby inducing relaxation of the target muscle. An example is the relationship between the biceps and triceps, which both control movement of the upper arm. When the bicep is contracted, the tricep is reciprocally inhibited. Similarly, when the tricep is contracted, the bicep is reciprocally inhibited.

By incorporating reciprocal inhibition into the treatment protocols of the present invention, a medical or health practitioner can elicit a relaxation response of the target muscle(s), thereby positively affecting the strength of the target muscle(s). If a target muscle has been diagnosed as requiring strengthening, relaxation of the target muscle can be induced through applying resistance to the movement of the muscle(s) in opposition to the target muscle's movements, namely the target muscle's antagonist. The patient lightly contracts the muscles of opposite action (i.e. the antagonists of the target muscle(s)). This light contraction can be less than approximately 20% of the maximal effort when fully contracting the antagonist, preferably between 10 to 20% of the maximal effort when fully contracting the antagonist. The antagonist of the target muscle(s) should be contracted at less than approximately 20% of its maximal effort so as to prevent the recruitment of collateral muscles. While the patient contracts the antagonists of the target muscle(s), the health practitioner can resist the movement of the target muscle's antagonist with sufficient force not only to induce the contraction of the target muscle's antagonist but also to allow the antagonist to move substantially through its full range of motion. Alternatively, the patient, without the aid of a health practitioner, can use a stationary object to provide the necessary resistance thus inducing the contraction of the target muscle's antagonist.

(ii) The Lengthening Procedure

The inverse myotatic reflex, also known as autogenic inhibition and the clasped-knife reflex, is another known neurophysiologic reflex that allows for coordinated muscle action. When a target muscle (i.e. the agonist) contracts, the contraction can produce tension at the point where the muscle is connected to the tendon. Located at this point are the Golgi tendon organs, which record changes in tension and the rate of change of the tension via proprioceptors. Via proprioceptors, the Golgi tendon organs transmit signals to the spine to convey changes in tension and the rate of change of the tension. If the tension exceeds a preset threshold, a lengthening reflex is triggered that results in the inhibition of further muscle contraction and the induction of muscle relaxation. This reflex helps to protect the muscles, tendons, ligaments and joints from injury.

By incorporating the inverse myotatic reflex into the treatment protocols of the present invention, a medical or health practitioner can also elicit a relaxation response of the target muscle(s), thereby positively affecting the length of the target muscle(s). If a target muscle is diagnosed as requiring lengthening, relaxation of the target muscle can be induced through applying resistance to the movement of the target muscle(s) itself, namely the target muscle agonist. This is distinct from the strengthening protocols, which utilizes reciprocal inhibition. Unlike the strengthening protocol, the lengthening protocol involves the resistance of the movement of the agonist per se, not the antagonist. In the lengthening protocol, the patient strongly contracts the agonist muscle(s) of the target site. This strong contraction by the patient can be more than approximately 80% of the maximal effort when fully contracting the agonist, preferably between 80 to 95% of the maximal effort when fully contracting the agonist.

As with the strengthening protocol, the health practitioner should resist the movement of the agonist target muscle(s) with sufficient force to induce the relaxation of the agonist(s) but with insufficient force so as to allow the agonist to move through its substantially full range of motion. Alternatively, the patient, without the aid of a health practitioner, can use a stationary object to provide the necessary resistance thus inducing the relaxation of the agonist target muscle(s).

With muscle(s) associated with the target site(s) that have been found to require lengthening, such as, for example, hypertonic or fibrocytic muscles, the strengthening procedure may be conducted to initially relax or unload the muscle(s) associated with the target site(s). The health practitioner may also choose to do strengthening applications followed by lengthening applications or alternating strengthening and lengthening to muscles individually.

B. Stimulation of Application Points

While utilizing the reflexogenic neurophysiology to induce relaxation of the muscles of the target site, the application points associated with the target site(s) selected and/or identified during the assessment and diagnosis protocols can be simultaneously or concurrently stimulated. In a preferred embodiment, the application point(s) can be stimulated while the reflexogenic neurophysiology is conducted on the muscles associated with the target site(s).

The stimulation can take the form of external pressure applied to the application points. The pressure applied to the application points further induces relaxation or unloading of the muscles associated with target site(s). The external pressure can be applied by either the health practitioner or by the patient. If the external pressure is applied by the health practitioner, the use of external pressure applied to the application point(s) also provides the health practitioner with a means to monitor the extent to which the muscle(s) associated the target site(s) relax and unload. In doing so, the health practitioner can, if necessary modify the treatment protocol to obtain a maximal relaxation response or to facilitate the relaxation response further. It will be understood that the patient could also be taught by a health practitioner to conduct similar self monitoring of the treatment protocol while the patient exerts the external pressure.

The amount of external pressure to be exerted or the degree to which external pressure is applied by the health practitioner or the patient at the application point, which can be characterized by the depth to which the soft tissue associated with the application point(s) gives, must also be considered. An important factor in assessing the degree of pressure to apply is the soft tissue associated with the application point. The degree of pressure to be exerted can depend on the size or the extent to which the soft tissues associated with the application point(s) are surrounded by other anatomical structures. For example, if a muscle associated with the application point is large or deep within other soft tissues (e.g. fascial structures), the health practitioner or the patient may choose to apply more external pressure than if the muscle was small or not deep within other soft tissues. It is preferable that the health practitioner or the patient applies sufficient pressure to the soft tissue associated with the application point(s) to assist in the relaxation response induced by the reflexogenic neurophysiology, but not so much pressure so as to elicit a jump sign. A health practitioner or a patient should appreciate that the pressure exerted on the soft tissue associated with the application point(s) may depend on other factors, such as, for example, the age of the patient, the patients' belief systems, the amount of pain perceived by the patient and the degree of fragility of the patient's body.

It is surprising that, when external pressure is applied to the so8t tissues associated with the application point concurrently or simultaneously with the reflexogenic neurophysiology procedures, the amount of external pressure to be exerted or the degree to which external pressure is applied in order to elicit a jump sign has been found by the inventor to be increased. It is possible, therefore, that the health practitioner or the patient can go “deeper” (i.e. apply more external pressure to the soft tissue of the application point(s)) into the soft tissue associated with the application point(s). In doing so, a more beneficial result, such as, for example, increased unloading of the muscle(s) associated with the target site(s), can be obtained.

In an aspect of the present invention, the exertion of external pressure by the health practitioner or patient on the soft tissue associated with the application point(s) can involve the application of pressure directed simultaneously and/or concurrently downward with oblique, semicircular, lengthwise or transverse pressure to the soft tissues associated with the application point(s), such as, for example, muscle fibres. For example, external pressure applied to a muscle fiber or tendon from the side of the muscle fibre or tendon so as to bend and further stretch the area of muscle or tendon can also be used. The external pressure applied to the soft tissue associated with the application point does not involve movement that is intended to “strip” the soft tissues associated with the application point(s). The direction of pressure applied by the health practitioner may depend on the area of involvement and the relaxation response of the tissue.

The pressure exerted on the soft tissue associated with an application point is generally localized to the area of application. The pressure exerted on the soft tissue associated with the application point does not move along the soft tissue associated with the application point, nor does it involve only direct pressure exertion. It involves variations in pressure and direction without any substantial change in the contact area of application. The tissue is essentially traction stretched (or “bent”) while it's moving without actually being “stripped.”

The pressure at the application point can be exerted in a dynamic fashion, namely having at least two directional axes. The exerted pressure can be applied to the surface of the patient's skin on or near the application point by pressing on the skin and down into the soft tissue of the application point in a first directional axis that is perpendicular to a longitudinal axis of the soft tissue associated with the application point (the “downward axis”). In addition to the pressure exerted along the downward axis, pressure can also be exerted in a second directional axis that can be transverse to or longitudinal along the horizontal axis of the soft tissue. The pressure exerted in the second directional axis may be applied concurrently, simultaneously or sequentially, with the first directional axis. Furthermore, the exerted pressure may also have a third directional axis that is parallel to the longitudinal axis of the soft tissue but which is torsional or semi torsional in nature. In such embodiments the three directional axes may be applied concurrently, simultaneously or sequentially,

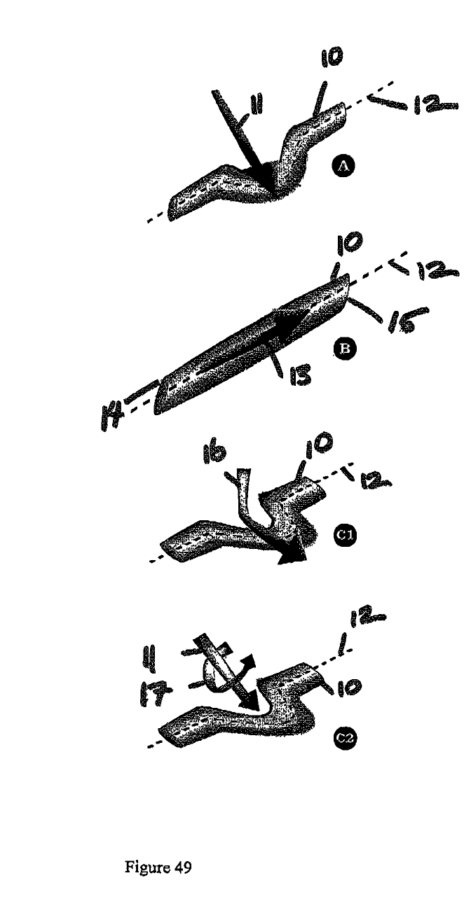

Examples of the directions in which the exerted pressure can be applied are provided in FIG. 49. In all of FIGS. 49(A) to 49(C2), there is pressure exerted downward that is not shown.

FIG. 49(A) shows an aspect of the present invention, namely the second directional axis in which the exerted pressure can be applied sequentially with the first directional axis. As shown in FIG. 49(A), the exerted pressure can be applied to the soft tissue of the application point in a transverse fashion. The soft tissue of the application point is represented in FIG. 49(A) by fiber 10. It will be understood that fiber 10 may comprise a muscle fiber, a tendon or other soft tissue associated with an application point. In a preferred aspect, the health practitioner exerts pressure on fiber 10, in a direction represented by arrow 11. As seen in FIG. 49(A), this “transverse traction” in the direction represented by arrow 11 is transverse to the longituntinal axis 12 of the fiber 10 so as to create a localized area of extension within fiber 10. A health practitioner may also apply transverse traction in the direction opposite to the direction represented by arrow 11 (“opposite transverse traction”). In addition, pressure exerted by way of transverse traction can be combined with pressure exerted by way of opposite transverse traction.

FIG. 49(B) shows another embodiment of the second directional axis in which the exerted pressure can be applied sequentially with the first directional axis. As shown in FIG. 49(B), the exerted pressure can be applied to the soft tissue of the application point in a longitudinal fashion. The soft tissue of the application point is represented in FIG. 49(B) by fiber 10. The health practitioner exerts pressure on fiber 10, in a direction represented by arrow 13. As seen in FIG. 49(B), this “longitudinal traction” in the direction represented by arrow 13 is parallel to the longituntinal axis 12 of the fiber 10 in a direction from the proximal end 14 to the distal end 15. In the case of FIG. 49(B), the use of the terms “distal” and “proximal” are relative to fiber 10. A health practitioner may also apply longitudinal traction in the direction opposite to the direction represented by arrow 13, namely in the direction of distal end 15 to proximal end 14 (“opposite longitudinal traction”). In addition, pressure exerted by way of longitudinal traction can be combined with pressure exerted by way of opposite longitudinal traction.

FIG. 49(C1) and FIG. 49(C2) show further embodiments in which the first second and third directional axes are applied concurrently or simultaneously. As shown in FIG. 49(C1), the exerted pressure can be applied to the soft tissue of the application point in the first directional axis and simulataneously in the second transverse directional axis represented by arrow 11 as shown in FIG. 49(A). The soft tissue of the application point is represented in FIG. 49(C1) by fiber 10. The health practitioner exerts pressure on fiber 10, in the first and second directional axes represented by arrow 16. As seen in FIG. 49(B), this “vertical torsional traction” in the direction represented by arrow 16 is a combination of the first and second directional axes noted above. FIG. 49(C2) shows the application of the first directional axis with simultaneous exertion of pressure along a third directional axis parallel to the longituntinal axis 12, but in a counterclockwise torsional direction indicted by arrow 17 (“horizontal torsional traction”). The direction indicated by arrow 17 may be either clockwise or counter-clockwise.

The pressure exerted by the health practitioner can be exerted on the soft tissue associated with the application point in a number of ways using a number of different parts of the body. The parts of the health practitioner's body which can be used to apply the exerted pressure include the thumb, the distal, medial and proximal phalanxes of the fingers either individually or together, the distal or proximal interphalangeal joints of the thumb or fingers, the distal phalanxes of the 4 fingers in a “knife edge” manner using one or both hands, the heel of the hand, a heel/palm contact of the hand, the pisiform, the elbow, the forearm, and the fists. In order to decrease muscle or joint fatigue of the medical or health practitioner exerting the pressure to the soft tissues associated with the application point, application devices can also be used, two examples of which include the TRIGGERIZER and the TRIGENERATOR.

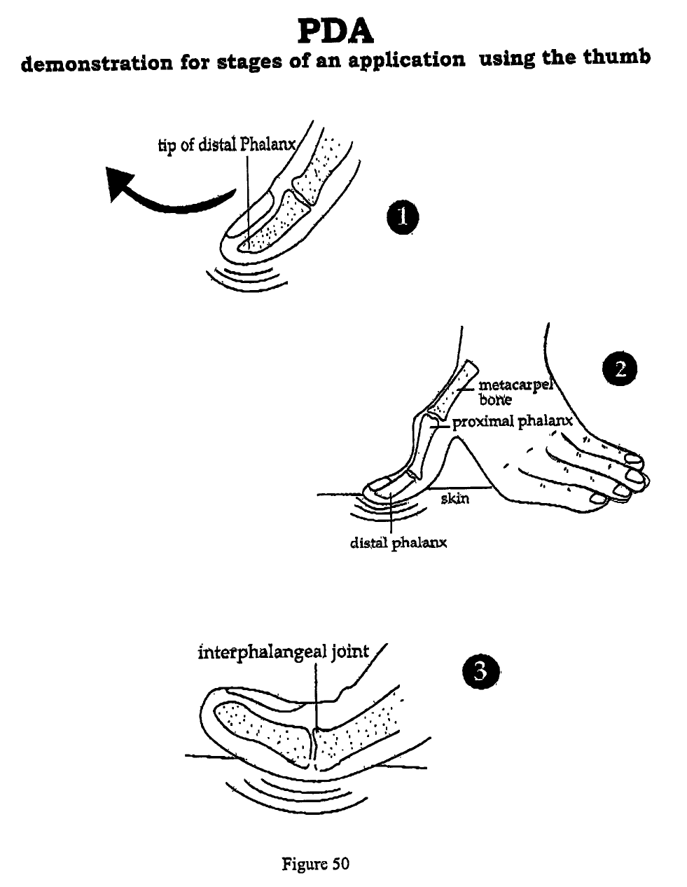

If the pressure is exerted by a health practitioner or a patient, the specific anatomical location of the health practitioner's or patient's body being used for application can change. In one embodiment, the pressure can be exerted using the thumb, but in the course of applying the pressure to the soft tissue of the application point, the part of the thumb which contacts the soft tissue may change. The pressure exerted by the thumb involves changing the part of the thumb being used from the tip of the phalanx to the interphalangeal joint and vice versa as shown in FIG. 50(1), (2) and (3). This application may also involve a tractional rolling or, conversely, a tractional scooping type of movement by the thumb as illustrated in FIG. 50. Another application using the thumb involves rolling or scooping the thumb from it's lateral to its medial edge.

The medical or health practitioner exerts pressure while monitoring the response of the soft tissue associated with the application point. The health practitioner can then alter the amount of pressure exerted as well as the direction of the pressure exerted in response to the condition of the soft tissue of the application point, as the soft tissue responds to the treatment protocol. Pressure is being applied to the soft tissue associated with the application point while the agonist and/or antagonist muscle(s) associated with the target(s) is (are) being contracted and the contraction is being resisted.

In a preferred aspect of the present invention, the health practitioner or the patient may exert pressure on the soft tissues associated with the application point(s) while the agonist or antagonist muscle(s) associated with the target site(s) move through their intended range of motion while the reflexogenic neurophsiological induced relaxation or unloading is accomplished. Relaxation of the agonist or antagonist muscle(s) associated with the target site(s) induced by the reflexogenic neurophsiological pathways are enhanced.

The application of external pressure to the soft tissue associated with the application point can be accomplished through the use of several areas of the health practitioner's body. For example, the dynamic external pressure may be applied through the use of either the elbow or the heel of the hand of the health practitioner. The use of the thumb, the pisiform or the thenar and hyothenar eminences, as well as one of a combination of one, some or all of the digits of the hand may also be used. Alternatively, the dynamic external pressure may be applied through the use of a suitable device so as to decrease strain on the appendages of the health practitioner.

C. Patient Directed Relaxation Techniques

While utilizing reflexogenic neurophysiology and stimulation of application points to induce relaxation of the muscles associated with the target site(s), patient directed, with or without assistance from a health practitioner, relaxation techniques, such as, for example, “visualization”, “abdominal breathing” or other known techniques, are used to induce relaxation of the muscles associated with the target site(s). In a preferred aspect, the patient directed relaxation technique of the muscles associated with the target site(s) is conducted concurrently or simultaneously with application point stimulation and reflexogenic neurophysiology.

In a preferred aspect of the present invention, the health practitioner may also use verbal instruction to assist the patient undergoing patient directed relaxation techniques to keep focused on relaxation of the muscle(s) associated with the target site(s) as well as to continue to exhale and perform the movement involved in the reflexogenic neurophysiology. In order to assist with the conscious relaxation of the soft tissue associated with the application point(s), the health practitioner can repeatedly direct the patient throughout the procedure to visualize relaxation of the soft tissue associated with the application point(s). In one aspect of the invention, a practitioner may verbalize a relaxation routine for the patient.

The following non-limiting examples set forth preferred methods for use in practising the present invention. These working examples show numerous applications of the principles of soft tissue manipulation seeking therapeutic benefit.

### EXAMPLE 1

### Strengthening Protocol of The Coracobrachialis

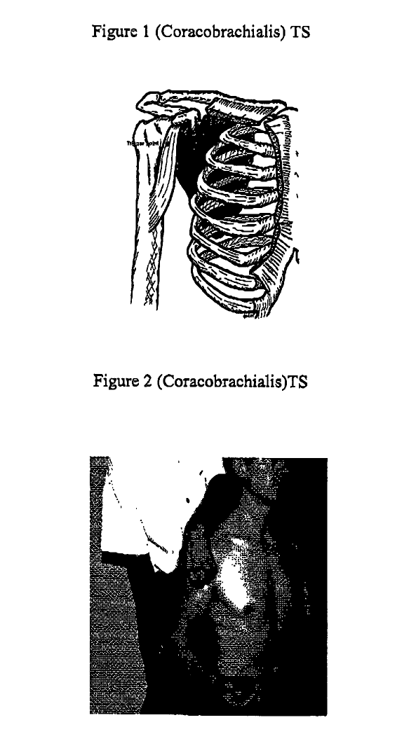

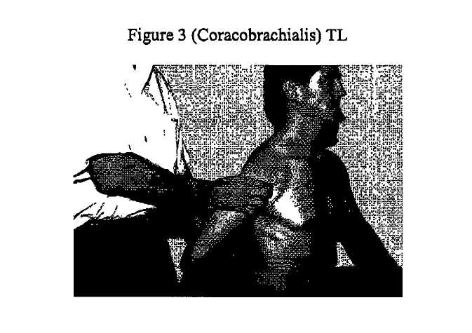

A strengthening protocol of the coracobrachialis is provided in FIGS. 1 and 2 and is further described as provided below:

| | |
|---|---|
| Patient | Seated at the side of the table. The involved shoulder is at rest, the elbow is |
| Position: | flexed 90° and the forearm is supinated. |
| Health | Standing behind the patient. The index and middle fingers of the contact hand |
| practitioner | are on the application point(s). The mid palm of the support hand cups the |
| Position: | patient's involved elbow while the fingers support the proximal flexed forearm. |
| Application | PC-2: 2 cun below the end of the anterior axillary fold, between the two heads |
| Point | of the Biceps Brachii muscle of the arm. |
| Locations: | Trp-1: Located on the distal surface of the muscle (not shown). |
| Trp pain | Refers pain upward to the anterior Deltoid region and occasionally the |
| referral: | suprascapular region and the antecubital space. |
| Procedure: | a) The patient extends and slightly abducts the shoulder, keeping the elbow |
| | bent. The Health practitioner provides resistance while allowing for near |
| | full extension. Repeat the procedure, if necessary, no more than 3 times |
| | per application point. |
| Action: | Shoulder: Flexion, adduction |
| | Elbow: Flexion |
| | Forearm: Supination (main supinator while the elbow is flexed) |

### EXAMPLE 2

### Lengthening Protocol of The Coracobrachialis

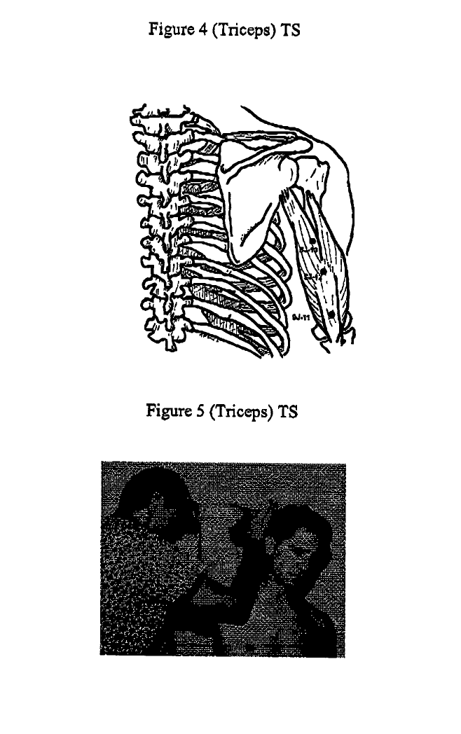

A lengthening protocol of the coracobrachialis is provided in FIGS. 1 and 3 and is further described as provided below:

| | |
|---|---|
| Patient | Seated on the side of the table. The involved forearm is placed behind the |
| Position: | patient's back in a supinated position. The elbow is flexed approximately 90°. |
| Health | Standing behind the patient. The Health practitioner places the index finger of the |
| practitioner | contact hand on the application point. The support hand holds the patient's wrist |
| Position: | comfortably behind their back. |
| Application | TRP: It is located just inferior and lateral to the coracoid process. The trigger |
| Point | point is usually found along the proximal half of the muscle. |
| Locations: | |
| Trp pain | Refers pain over the anterior Deltoid, posterior arm, forearm, hand, and middle |
| referral: | finger. The pain tends to skip both the elbow and wrist joint. |
| Procedure: | a) The patient attempts to simultaneously extend and abduct the shoulder |
| | while extending the elbow and slightly pronating the forearm. This will |
| | draw the hand away from the body inferolaterally and the shoulder |
| | forward. |
| | b) When the patient relaxes, the arm will be repositioned more superiorly |
| | than the original position. Repeat the procedure, if necessary, no more |
| | than 3 times per application point. |
| Action: | Shoulder: Flexion, adduction |
| NOTE: | 1) This procedure is effective in loosening the holding elements of the |
| | glenohumeral joint in FROZEN SHOULDER. |
| | 2) Although this region may be a major source of irritation or the primary |
| | area of pain, the Coracobrachialis trigger point may sometimes only |
| | reveal itself after other Trp's have been cleared out (Deltoid, Pectoralis |
| | Major, Supraspinatus and Biceps Brachii). The active trigger point of |
| | Coracobrachialis is often secondary to active trigger points in related |
| | muscle groups. |
| | 3) This is not a pure move but because the Triceps Brachii extends the |
| | shoulder, this will reciprocally inhibit the Coracobrachialis |

### EXAMPLE 3

### Strengthening Protocol of The Triceps Brachii

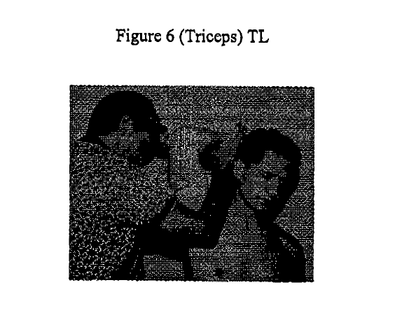

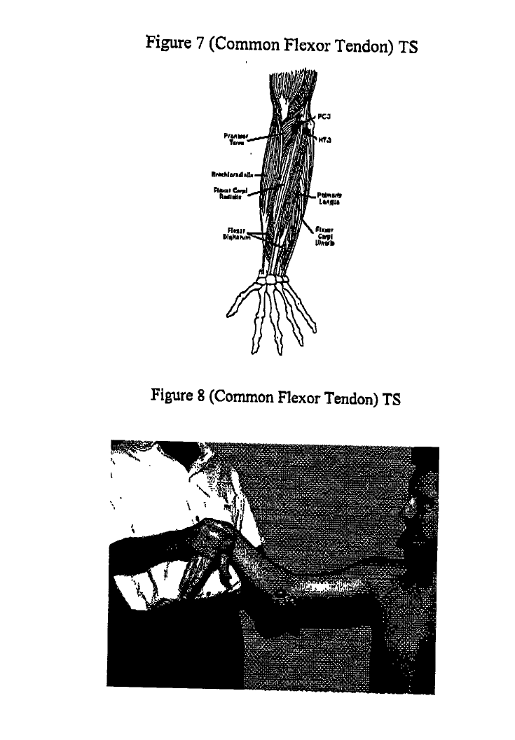

A strengthening protocol of the triceps brachii is provided in FIGS. 4 and 5 and is further described as provided below:

| | |
|---|---|
| Patient | Sitting on the side of the table, with the shoulder of the involved arm flexed to just |
| Position: | above horizontal and the involved elbow flexed to 90 degrees. The forearm is |
| | slightly pronated. |
| Health | Sitting on the side of the table facing the patient's involved shoulder. The Health |
| practitioner | practitioner's right support hand is placed underneath the distal end of the flexed |
| Position: | elbow. The palm of the Health practitioner's contact hand contacts the application |
| | point. (The support hand and contact hand may be switched.) |
| Application | SJ-11: When elbow is flexed, the point is about 2 cun superior to the olecranon. |
| Point | |
| Locations: | |
| | SJ-12: It is just on the lower end of the bulge of the lateral head of the Triceps |
| | Brachii muscle of the arm when the forearm is in pronation. |
| | SJ-13: On the posterior aspect of the upper arm, in the depression 3 cun from |
| | the tip of the shoulder. |
| | Trp-1: Located deep in the long head of the Triceps Brachii muscle just |
| | proximal to its mid belly. |
| | Trp-2: Located in the distal lateral portion of the medial head of Triceps |
| | Brachii. |
| | Trp-3: Located in mid-belly in the lateral portion of the lateral head of |
| | Triceps Brachii. |
| | Trp-4: Located deep in the medial border of the medial head of Triceps |
| | Brachii just above the olecranon process and close to the midline. |
| | Trp-5: Located deep in the medial border of the medial head of the Triceps |
| | Brachii just above the medial epicondyle. |
| Trp pain | Trp-1: Refers pain upward over the posterior arm, back of shoulder and |
| referral | occasionally over the upper Trapezius. |
| | Trp-2: Refers pain downward towards the lateral epicondyle, and radial portion |
| | of the forearm (associated with tennis elbow). |
| | Trp-3: Refers pain over the posterior arm, dorsum of the forearm, and |
| | occasionally the 4^{th} and 5^{th} digits (caused by the entrapment of radial |
| | nerve). |
| | Trp-4: Refers pain over the posterior arm, dorsum of the forearm, and |
| | occasionally the 4^{th} and 5^{th} digits (caused by the entrapment of radial |
| | nerve). |
| | Trp-5: Refers pain to the medial epicondyle, ventral surface of the 4^{th} and 5^{th} |
| | digits, and occasionally the palm and middle finger. |
| Procedure: | The patient flexes the elbow and shoulder and supinates the forearm. The Health |
| | practitioner resists and allows for elbow flexion and forearm supination to about |
| | 90% of full range. Repeat the procedure, if necessary, no more than 3 times |
| | per application point. |
| Action: | Shoulder: Extension, adduction, also steadies head of abducted Humerus |
| | Elbow: Extension |
| NOTE: | 1) It may be helpful to work along the whole tendon. |
| | 2) Patient complains of vague, hard to localize pain in the posterior arm and |
| | shoulder. DDX include arthritis of the elbow joint, C7 radiculopathy, and |
| | cubital tunnel syndrome (hypoesthesia in the ulnar distribution, along with |
| | weakness and clumsiness of the hand). |
| | 3) Biceps Brachii and Triceps Brachii fire very quickly due to their |
| | representation on the brain. Therefore, move very slowly and with a small |
| | amount of light force due to the low threshold of the muscular twitch. Do |
| | not go to full range. |

### EXAMPLE 4

### Lengthening Protocol of The Triceps Brachii

A lengthening protocol of the triceps brachii is provided in FIGS. 4 and 6 and is further described as provided below:

| | |
|---|---|
| Patient | Sitting on the side of the table, with the shoulder and elbow of the involved arm |
| Position: | fully flexed. |
| Health | Sitting on the side of the table facing the patient's involved shoulder. The Health |
| practitioner | practitioner's right support hand is placed over the distal end of the flexed elbow. |
| Position: | The thumb of the Health practitioner's contact hand contacts the application point. |
| Application | Tender Points are located along in the center of the belly of the Triceps Brachii |
| Point | muscle. |
| Locations: | |
| | SJ-11: When the elbow is flexed, the point is about 2 cun superior to the |
| | olecranon. |
| | SJ-12: It is just on the lower end of the bulge of the lateral head of the Triceps |
| | Brachii muscle of the arm when the forearm is in pronation. |
| | SJ-13: On the posterior aspect of the upper arm, in the depression 3 cun from the |
| | tip of the shoulder. |
| | Trp-1: Located deep in the long head of the Triceps Brachii muscle just proximal |
| | to its mid belly. |
| | Trp-2: Located in the distal lateral portion of the medial head of Triceps Brachii. |
| | Trp-3: Located in mid-belly in the lateral portion of the lateral head of |
| | Triceps Brachii. |
| | Trp-5: Located deep in the medial border of the medial head of the Triceps |
| | Brachii just above the medial epicondyle. |
| Trp pain | Trp-1: Refers pain upward over the posterior arm, back of shoulder and |
| referral | occasionally over the upper Trapezius. |
| | Trp-2: Refers pain downward towards the lateral epicondyle, and radial portion |
| | of the forearm (associated with tennis elbow). |
| | Trp-3: Refers pain over the posterior arm, dorsum of the forearm, and |
| | occasionally the 4^{th} and 5^{th} digits (caused by the entrapment of radial nerve. |
| | Trp-4: Refers pain over the posterior arm, dorsum of the forearm, and |
| | occasionally the 4^{th} and 5^{th} digits (caused by the entrapment of radial nerve. |
| | Trp-5: Refers pain to the medial epicondyle, ventral surface of the 4^{th} and 5^{th} |
| | digits, and occasionally the palm and middle finger. |
| Procedure: | The patient extends their elbow to about 90 degrees as PDA is applied to the |
| | application point. (The Health practitioner must have full relaxation of the |
| | Triceps before digital pressure is applied.) The Health practitioner then flexes the |
| | shoulder and the elbow to a new endpoint before applying the procedure again. |
| | Repeat the procedure, if necessary, no more than 3 times per application point. |
| | NB: The heel-palm may also be used to apply PDA. In this case the patient |
| | will be allowed to simultaneously extend the shoulder slightly while |
| | resistance is applied to a broad application point. |
| Action: | Shoulder: Extension, adduction, also steadies head of abducted Humerus |
| | Elbow: Extension |

### EXAMPLE 5

### Strengthening Protocol of The Common Flexor Tendon

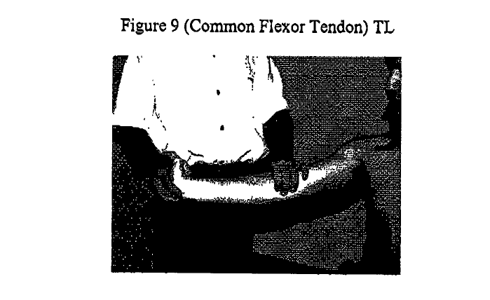

A strengthening protocol of the Common Flexor Tendon is provided in FIGS. 7 and 8 and is further described as provided below:

| | |
|---|---|
| Patient | Seated or standing. The shoulder of the involved arm is slightly flexed, the arm is |
| Position: | in full pronation, the elbow is flexed 90°-110°, the wrist is fully flexed. |
| Health | Facing the patient. The support hand is placed on the dorsum of patient's hand. |
| practitioner | The 3rd finger of contact hand is placed on the Application Point. The Health |
| Position: | practitioner will draw the patient's forearm passively to the end point of pronation |
| | prior to commencing the procedure. |
| Application | PC-3: On the transverse cubital crease, on the medial side of the bicep tendon. |
| Point | HT-3: It is located on the medial end of the transverse cubital crease, just |
| Locations: | anterior to the medial epicondyle. |
| Procedure: | The patient slowly extends the elbow while supinating the forearm and then |
| | extends the wrist at the end of supination. The Health practitioner bends the |
| | application point by applying PDA transverse to the tendon. Repeat the |
| | procedure, if necessary, no more than 3 times per application point. |
| Action: | Elbow: Flexion |
| | Wrist and fingers: Flexion |
| NOTE: | An alternate method, which in some cases may prove to be easier, has the Health |
| | practitioner switching hands and using the thumb of the opposite hand to contact |
| | the Application Point. |

### EXAMPLE 6

### Lengthening Protocol of The Common Flexor Tendon

A lengthening protocol of the Common Flexor Tendon is provided in FIGS. 7 and 9 and is further described as provided below:

| | |
|---|---|
| Patient | Standing or sitting. The arm on the involved side is extended and fully supinated, |
| Position: | and the wrist is extended and radially deviated. |
| Health | Facing the patient. The Health practitioner holds the patient's elbow from above, |
| practitioner | the 3rd finger of the contact hand on the application point at or near PC-3 |
| Position: | (common flexor tendon attachment, medial epicondyle). The support hand is palm |
| | to palm with the patient. NB: The Health practitioner may also apply PDA to the |
| | application point by grasping the patient's arm at HT-3 from underneath (rather |
| | than from above as in the picture). |
| Application | PC-3: On the transverse cubital crease, on the medial side of the bicep tendon. |
| Point | HT-3: It is located on the medial end of the transverse cubital crease, just anterior |
| Locations: | to the medial epicondyle. |
| | MP-1 (see diagram) |
| | MP-2 (see diagram) |
| | MP-3 (see diagram) |
| | Tender point: located in the center of the common tendon at about MP-2. |
| Procedure: | 1) The patient attempts to flex the wrist and then the elbow. The Health |
| | practitioner allows about 25% flexion of the wrist with minimal flexion of |
| | the elbow. |
| | 2) Pull the wrist back into full extension. This point should now be farther |
| | back than the original starting position being careful not to hyperextend the |
| | elbow (leave 5° of flexion.) |
| | 3) Perform the procedure at least three times lengthening the muscle further |
| | each time. |
| Action: | Elbow: Flexion |
| | Wrist and fingers: Flexion |

### EXAMPLE 7

### Strengthening Protocol of The Psoas

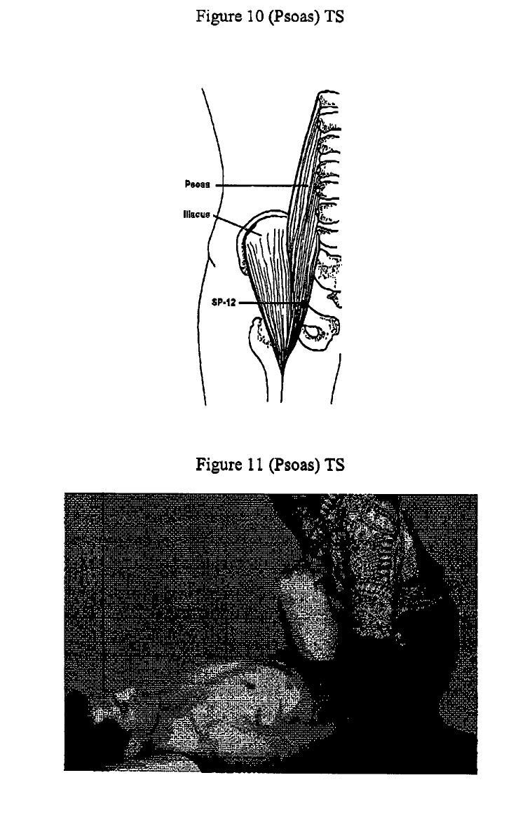

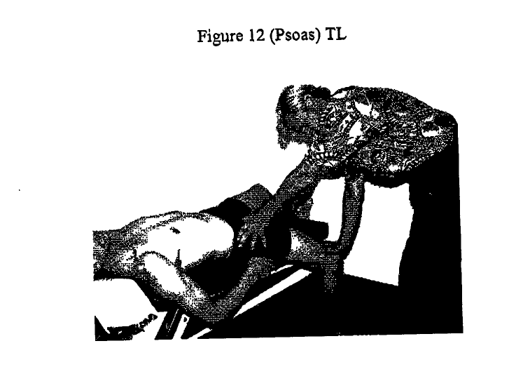

A strengthening protocol of the psoas is provided in FIGS. 10 and 11 and is further described as provided below:

| | |
|---|---|
| Patient | Supine. The hip and knee on the involved side are fully flexed, adducted and |
| Position: | internally rotated bringing the involved knee toward the contralateral shoulder. |
| Health | Standing on the patient's involved side at the level of the patient's knee and |
| practitioner | facing towards the patient's head. The thumb of the contact hand (furthest from |
| Position: | the table) is placed on the Application Point. The support hand holds the |
| | patient's involved leg below the knee, and the Health practitioner will passively |
| | flex the patient's hip fully. |
| Application | SP-12: Along the inguinal groove, just lateral to the Femoral artery. |
| Point | |
| Locations: | |
| Trp pain | TRP-1: Lateral to origins on the L3 vertebrae. |
| referral: | |
| | TRP-2: Inferior to lateral origin on iliac fossa. |
| | TRP-3: Superior to insertion on lesser trochanter. |
| | Referral Pattern is vertical and ipsilateral along the lumber spine and extending |
| | into the sacroiliac region and upper medial buttock. This pattern also includes |
| | the ipsilateral groin and upper anteromedial thigh. |
| Procedure: | a) The patient extends and externally rotates the hip. The Health |
| | practitioner resists and applies PDA by pressing the contact thumb |
| | medially (transverse to the muscle fibres) while allowing the involved |
| | leg to slowly drop to the floor. (In some cases the leg will only be |
| | dropped as far as the table.) PDA is specifically applied using torsional |
| | transverse pressure by rotating the thumb around its longitudinal axis |
| | medially or laterally. |
| | b) Perform this procedure 3 times for each application point before moving |
| | to the next application point location. Start first at SP-12 and then move |
| | upwards towards the origin. |
| Action: | Hip: Flexion (primary), abduction (assist), lateral rotation |
| NOTE: | 1. Health practitioner should use caution when applying pressure to this |
| | area. Pressure needs to be slow and gradual. Otherwise, it could lead to |
| | discomfort or a painful reaction. A more comfortable and sometimes |
| | safer contact is for the Health practitioner to use a “knife edge” (tips of |
| | the four fingers) contact. |
| | 2. When the foot reaches the floor, the Health practitioner may further |
| | abduct the hip by pulling it outward. The procedure may be further |
| | facilitated by pushing the patient's knee down and then hooking and |
| | pulling back the patient's foot using the Health practitioner's leg and |
| | foot. |
| | 3. This procedure is often followed by Psoas Trigenics Lengthening |
| | procedure. |
| | NB: a low-amplitude downward thrust may also then be applied to the |
| | lower thigh above the knee at the end of this procedure. |

### EXAMPLE 8

### Lengthening Protocol of The Psoas

A lengthening protocol of the psoas is provided in FIGS. 10 and 12 and is further described as provided below:

| | |
|---|---|
| Patient | Supine with the affected leg hanging off the table and the opposite leg |
| Position: | flexed at the hip |
| Health | Standing at the end of the table with the patients involved leg (the one off |
| practitioner | the table) held down by the Health practitioners right hand placed just |
| Position: | above the knee. The thumb of the contact hand applies PDA to the |
| | application point(s) of the Psoas muscle. |
| Application | SP-12: Along the inguinal groove, just lateral to the Femoral artery. |
| Point | |
| Locations: | |
| | MP-1 (see diagram) |
| | MP-2 (see diagram) |
| | MP-3 (see diagram) |
| Trp pain | TRP-1: Lateral to origins on the L3 vertebrae. |
| referral: | |
| | TRP-2: Inferior to lateral origin on iliac fossa. |
| | TRP-3: Superior to insertion on lesser trochanter. |
| | Referral Pattern is vertical and ipsilateral along the lumber spine and extending |
| | into the sacroiliac region and upper medial buttock. This pattern also includes |
| | the ipsilateral groin and upper anteromedial thigh. |
| Procedure: | a) The patient flexes the hip while the Health practitioner resists this |
| | motion. With this procedure, the Health practitioner only allows |
| | for about 10-20° of hip flexion. |
| | b) Perform this procedure 3 times for each application point before moving |
| | to the next application point location. Start first at SP-12 and then move |
| | upwards toward the origin. |
| Action: | Hip: Flexion (primary), abduction (assist), lateral rotation |
| NOTE: | 1. Health practitioner should use caution when applying pressure to this |
| | area. Pressure needs to be slow and gradual. Otherwise, it could lead to |
| | discomfort or a painful reaction. A more comfortable and sometimes |
| | safer contact is for the Health practitioner to use a “knife edge” (tips of |
| | the four fingers) contact. |

### EXAMPLE 9

### Strengthening Protocol of The Adductors

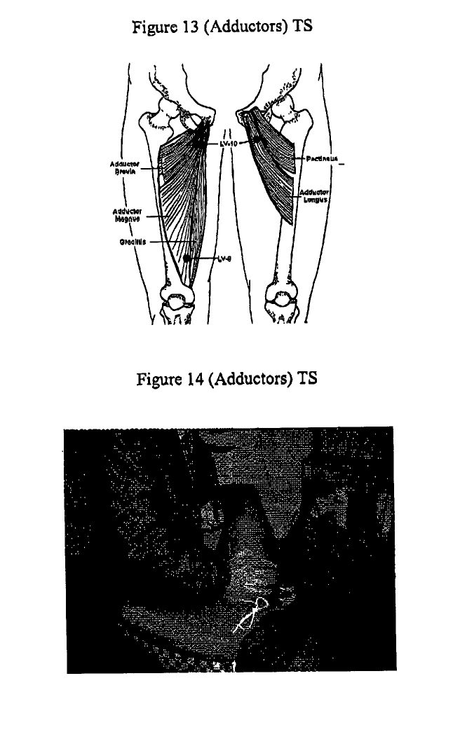

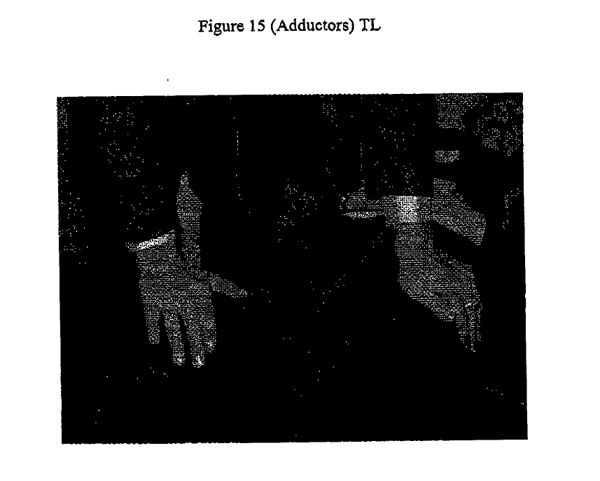

A strengthening protocol of the adductors is provided in FIGS. 13 and 14 and is further described as provided below:

| | |
|---|---|
| Patient | Supine. The knee and hip of the involved side are flexed 90°. The involved hip is |
| Position: | also externally rotated and adducted. The patient's leg should look like a FIG. 4. |
| Health | Sitting on the side of the table with the patient's involved leg hooked around the |
| practitioner | Health practitioner's waist. The patient's leg should be between the Health |
| Position: | practitioner's body and left arm. Health practitioner should be facing towards the |
| | patient's knee. The Health practitioner's left forearm hooks around and under the |
| | patient's leg with the 2^{nd}, 3rd and 4th fingers of both hands resting on the Trigenic |
| | Area (see Application Point Locations below). This is quite a “broad contact.” |
| | Palm of the hand may also be used as broad hand contact. |
| Application | LV-9: 4″ superior to the medial epicondyle of the Femur, between the Vastus |
| Point | Medialis and the Sartorius muscle. |
| Locations: | |
| | LV-10: 8″ below the umbilicus, 2″ lateral to the median line of the body, on |
| | the anterior border of the Adductor Longus muscle. |
| Trp pain | Adductor Longus and Brevis |
| referral: | Note: There is no distinction between the referral of pain and tenderness of these |
| | muscles. |
| | TRP: Located within belly of each muscle, respectively. |
| | RP: Pain deep within and proximal to the groin and anteromedial thigh. |
| | Pain refers distally from upper medial knee to anterior Tibia. |
| | Adductor Magnus |
| | TRP-1: Mid-portion of Adductor Magnus. |
| | RP: Deep pain moves up into the groin below the Inguinal ligament and down |
| | into anteromedial thigh almost to the knee. |
| | TRP-2: Slightly distal to ischial tuberosity. |
| | RP: Shooting pain inside the pelvis, can include the pubic bone, vagina, |
| | rectum and bladder. |
| | Gracilis |
| | TRP-1: Upper portion of Gracilis. |
| | RP: Local hot, stinging, superficial pain along medial thigh. |
| | TRP-2: Mid portion of Gracilis. |
| | RP: Same as TRP-1. |
| Procedure: | The patient flexes the hip by bringing the knee towards the shoulder on the same |
| | side. The Health practitioner applies cross fibre PDA while allowing movement to |
| | occur. Repeat the procedure, if necessary, no more than 3 times per |
| | application point. |
| Action: | Hip: adduction, some adductors may also assist in knee flexion or medial rotation |
| NOTE: | This Trigenic area is a more sensitive area than most Application Points. The |
| | Health practitioner may need to be more gentle here than in other areas. This |
| | particular procedure is primarily used to release the inferior portion of Adductor |
| | Magnus muscle. |

### EXAMPLE 10

### Lengthening Protocol of The Adductors

A lengthening protocol of the adductors is provided in FIGS. 13 and 15 and is further described as provided below:

| | |
|---|---|
| Patient | Patient is supine with the involved leg abducted, externally rotated and flexed 90° |
| Position: | at the hip with knee also flexed 90° forming a FIG.-4 configuration. |
| Health | Standing on the involved side of the table with your left leg forward and right leg |
| practitioner | extended. Your left hand rests on the ASIS and right hand on the medial aspect of |
| Position: | the thigh. Use broad contact over the medial aspect of the adductor group of |
| | muscles. The left hand places downward pressure on the ASIS to keep it from |
| | rising off the bench while the right applies PDA and presses downward to |
| | lengthen the adductors. |
| Application | LV-9: 4″ superior to the medial epicondyle of the Femur, between the Vastus |
| Point | Medialis and the Sartorius muscle. |
| Locations: | LV-10: 8″ below the umbilicus, 2″ lateral to the median line of the body, on the |
| | anterior border of the Adductor Longus muscle. |
| Trp pain | Adductor Longus and Brevis |
| referral: | Note: There is no distinction between the referral of pain and tenderness of these |
| | muscles. |
| | TRP: Located within belly of each muscle, respectively. |
| | RP: Pain deep within and proximal to the groin and anteromedial thigh. |
| | Pain refers distally from upper medial knee to anterior Tibia. |
| | Adductor Magnus |
| | TRP-1: Mid-portion of Adductor Magnus. |
| | RP: Deep pain moves up into the groin below the Inguinal ligament and down |
| | into anteromedial thigh almost to the knee. |
| | TRP-2: Slightly distal to ischial tuberosity. |
| | RP: Shooting pain inside the pelvis, can include the pubic bone, vagina, |
| | rectum and bladder. |
| | Gracilis |
| | TRP-1: Upper portion of Gracilis. |
| | RP: Local hot, stinging, superficial pain along medial thigh. |
| | TRP-2: Mid portion of Gracilis. |
| | RP: Same as TRP-1. |
| Procedure: | The patient adducts and medially rotates the thigh towards the midline against the |
| | Health practitioner's resistance. Repeat the procedure, if necessary, no more |
| | than 3 times per application point. |
| Action: | Hip: adduction, some adductors may also assist in knee flexion or medial rotation |
| NOTE: | This procedure can be modified by flexing the hip on each repetition which will |
| | further lengthen the fibers |
| Caution: | Posterior acetabular Osteoarthritis of the hip will limit your downward movement. |
| | Take it slowly on indication of the patient to proceed. You may find some portion |
| | of the global movement lost. Therefore, investigate movement with a general feel |
| | for the range of motion. Watch the patient's body language. |

### EXAMPLE 11

### Strengthening Protocol of The Hamstrings

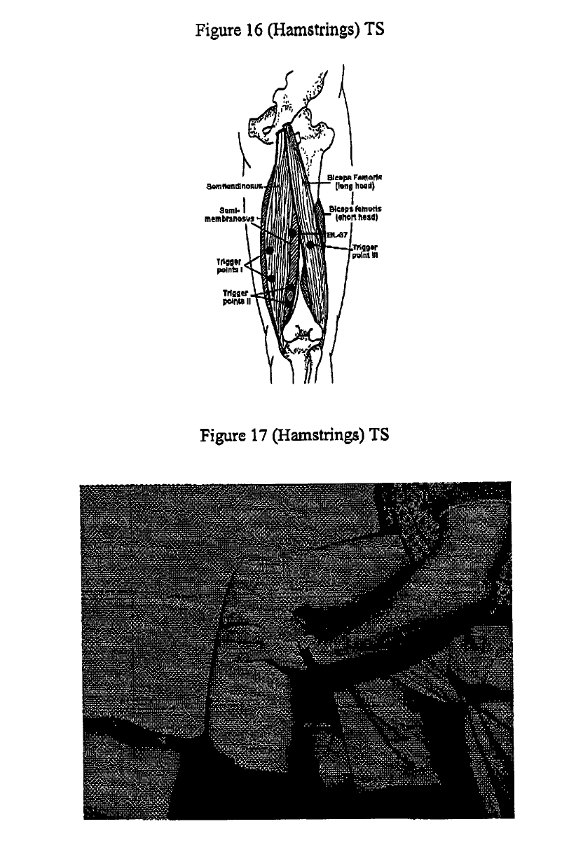

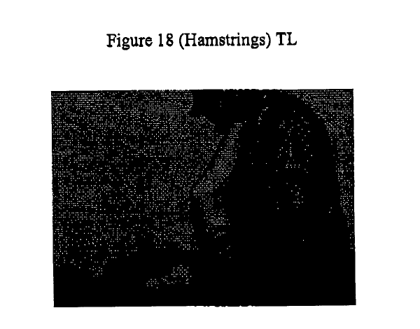

A strengthening protocol of the hamstrings is provided in FIGS. 16 and 17 and is further described as provided below:

| | |
|---|---|
| Patient | Supine. The knee and hip of the involved side are flexed 90°. |
| Position: | |
| Health | Standing at the side of the table, at the level of the patient's knee. The arm |
| practitioner | nearest the table is wrapped around the patient's lower leg. Both hands wrap |
| Position: | around the thigh at the level of the Application Point. The thumbs of both hands |
| | contact the Application Point. An alternate contact using a proximal phalanx |
| | contact of the Health practitioner's two fists can be used. The double fist contact |
| | is much broader and stronger than the double thumb contact. (More force can be |
| | applied by the Health practitioner using this alternate contact). |
| Application | BL-37: 6″ below the middle of the transverse gluteal fold, on the mid-posterior |
| Point | thigh. |
| Locations: | |
| | BL-38: 1″ above the knee joint line, on the medial side of the Biceps Femoris |
| | tendon. |
| | BL-39: On the popliteal crease and on the medial border of the Biceps Femoris |
| | tendon. |
| | Trigger points I (for Semitendinosus): Located in the medial distal half of the |
| | muscle belly. |
| | Trigger points II (for Semimembranosus): Located in the distal third of the muscle |
| | belly. |
| | Trigger point III (for Biceps Femoris): Located just inferior to the midway of the |
| | muscle belly. |
| Procedure: | The patient extends the hip and knee. The Health practitioner resists the |
| | movement, allowing approximately 30-40° of motion at the knee. The Health |
| | practitioner will apply PDA across the muscle, “bending” it with a “guitar string” |
| | contact. Repeat the procedure, if necessary, no more than 3 times per |
| | application point. |
| Action: | Hip: extension |
| | Knee: flexion |

### EXAMPLE 12

### Lengthening Protocol of The Hamstrings

A lengthening protocol of the hamstrings is provided in FIGS. 16 and 18 and is further described as provided below:

| | |
|---|---|
| Patient | Supine. The hip on the involved side is flexed as far as possible keeping about 10-20° |
| Position: | of flexion at the knee. |
| Health | Standing on the involved side of the table, with the calf or ankle of the patient's |
| practitioner | foot placed on the Health practitioner's shoulder nearest the table. The lengths of |
| Position: | the thumbs of both hands are placed on the lower hamstrings, 2-3 inches above |
| | the knee. This should be as broad contact as possible. The hands are wrapped |
| | around the patient's leg at that same level. The Health practitioner will allow the |
| | knee to bend slightly and then slightly increase the flexion of the hip. |
| Application | BL-37: 6″ below the middle of the transverse gluteal fold, on the mid-posterior |
| Point | thigh. |
| Locations: | |
| | Trigger points I (for Semitendinosus): Located in the medial distal half of the |
| | muscle belly. |
| | Trigger points II (for Semimembranosus): Located in the distal third of the muscle |
| | belly. |
| Procedure: | a) The patient will press the knee into an extended position by pressing the |
| | involved calf or ankle against the Health practitioner's shoulder. The |
| | patient will also focus on contracting the Quadriceps strongly. |
| | b) The Health practitioner will not allow any movement. At the same time, |
| | the Health practitioner will apply PDA against the hamstrings using the |
| | thumbs. The fingers can be used to gauge how well the patient is |
| | contracting the quadriceps. |
| | c) When the patient relaxes, the Health practitioner will increase the flexion |
| | of the leg with the knee only flexed slightly. Before repeating, the Health |
| | practitioner will allow slight flexion of the knee, again. |
| | d) Repeat the procedure, if necessary, no more than 3 times per |
| | application point. |
| Action: | Hip: extension |
| | Knee: flexion |

### EXAMPLE 13

### Strengthening Protocol of The Lateral Pterygoid

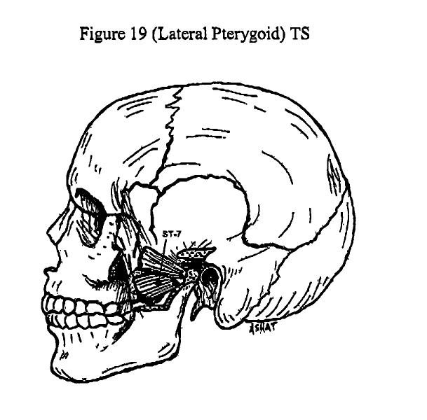

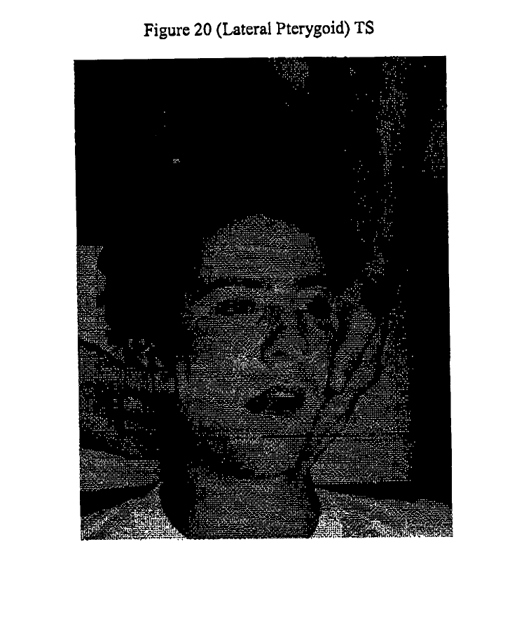

A strengthening protocol of the Lateral Pterygoid is provided in FIGS. 19 and 20 and is further described as provided below:

| | |
|---|---|
| Patient | Supine. The mandible is moved laterally toward the involved side. |
| Position: | |
| Health | Seated at the head of the patient. The thumb on the patient's involved side |
| practitioner | placed on the application point. The first three fingers of the supporting hand |
| Position: | will rest on the contralateral body of the mandible so that the palm of that hand |
| | is gently resting over the patient's ear. The Health practitioner's fingers will line |
| | up with the body of the mandible. |
| Application | ST-7: In the depression at the lower border of the zygomatic arch, anterior to |
| Point | the condyloid process of the mandible. |
| Location: | TP1 Mid-belly of superior head of lateral Pterygoid. |
| | TP2 Mid-belly of the inferior head of lateral Pterygoid. |
| TrP pain | Referral pattern manifests pain deep into the TMJ. |
| referral: | Note: The lateral Pterygoid is strongly associated with TMJ dysfunction |
| Procedure: | a) The patient moves the lower jaw away from the involved side. The |
| | Health practitioner applies pressure inferiorly and medially on the lateral |
| | pterygoid muscle and the mandible. While lightly resisting the motion, |
| | the Health practitioner allows for lateral deviation of the lower jaw away |
| | from the Application Point. Pressure may be applied with thumb or index |
| | finger |
| | b) The procedure is repeated with pressure being applied to the masseter |
| | muscle and to areas along the lower mandible. |
| | c) Repeat the procedure, if necessary, no more than 3 times per application |
| | point. |
| Attachments: | O: Superior head: Infratemporal surface and infratemporal crest of greater |
| | wing of sphenoid bone. |
| | Inferior head: Lateral surface of lateral pterygoid plate. |
| | I: Neck of mandible, articular disc, and capsule of TMJ. |
| Action: | TMJ (unilaterally): Ipsilateral deviation |
| | TMJ (bilaterally): Jaw opening; protrusion |

### EXAMPLE 14

### Strengthening Protocol of The Temporalis

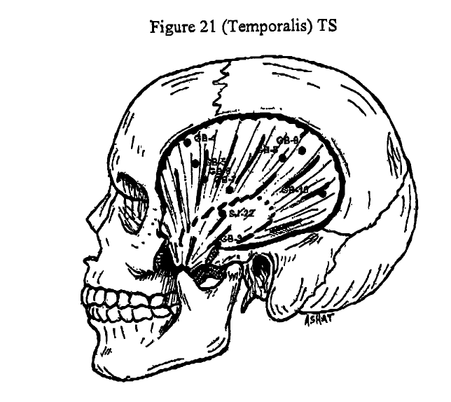

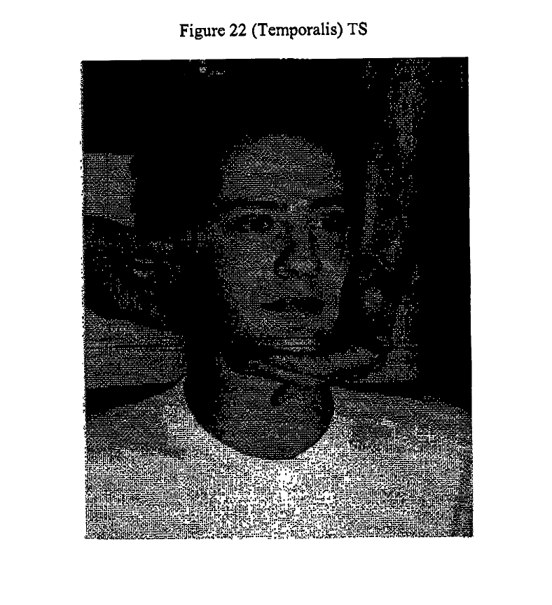

A strengthening protocol of the Temporalis is provided in FIGS. 21 and 22 and is further described as provided below:

| | |
|---|---|
| Patient | Supine. |
| Position: | |
| Health | Standing at the patient's head. The fingers of the Health practitioner's |
| practitioner | supporting hand are placed on the inferior surface of the patient's jaw. The |
| Position: | thumb of the contact hand is placed on the Application Point. |
| Mypoint | GB-3: On the side of the face anterior to the ear, on the upper border of the |
| Locations: | zygomatic arch, in the depression directly above ST-7. |
| | GB-4: Within the hairline of the temporal region, one quarter of the distance |
| | between ST-8 and GB-7. |
| | GB-5: Within the hairline of the temporal region, midway along a line |
| | connecting ST-8 and GB-7. |
| | GB-6: Within the hairline of the temporal region, midway between GB-5 and |
| | GB-7. |
| | GB-7: In a depression behind GB-6 in front of the ear behind the curved |
| | hairline. A space can be felt when the jaw is moved. |
| | GB-8: Superior to the apex of the auricle, 1.5” within the hairline. |
| | GB-9: Posterior and superior to the auricle, 2” within the hairline, about 0.5” |
| | posterior to GB-8. |
| | GB-10: Behind the ear, one inch within the hairline. |
| | SJ-22: Level with the root of the auricle, on the posterior border of the hairline |
| | of the temple, where the superficial temporal artety passes. |
| | TP1 Anterior portion of the muscle. |
| | TP2 Intermediate portion of the muscle above the mandibular fossa. |
| | TP3 Mid-portion of the muscle located above the coronoid process. |
| | TP4 Posterior portion of the muscle. |
| TrP pain | TP1 manifests pain above the eyes, and to the upper incisors. |
| referral: | |
| | TP2 manifests pain to the mid temporal region, and to the intermediate |
| | maxillary teeth. |
| | TP3 manifests pain just posterior to TP2. |
| | TP4 manifests pain to the posterior to TP3. |
| | Note: TP3 may refer pain into the maxilla and the TMJ. This muscle may also |
| | be a contributing factor to the cause of headaches with its close association with |
| | the temporal arteries. |
| Procedure: | The patient attempts to open their mouth. The Health practitioner resists the |
| | movement while sliding the thumb across the fibers of the Temporalis muscle. |
| | Repeat the procedure, if necessary, no more than 3 times per application point. |
| Attachments: | O: Temporal fossa and fascia |
| | I: Tip and medial surface of coronoid process and anterior border of ramus of |
| | mandible |
| Action: | Anterior fiber: TMJ (unilaterally): ipsilateral deviation |
| | TMJ (bilaterally): Jaw closure, protrusion |
| | Posterior fiber: |
| | Jaw opening, retraction |
| NOTE: | GB-4 and GB-5 are often used to relieve unilateral headaches. |

### EXAMPLE 15

### Strengthening Protocol of The Scalenes

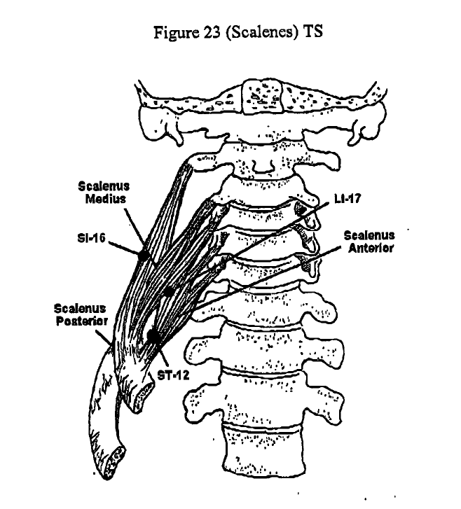

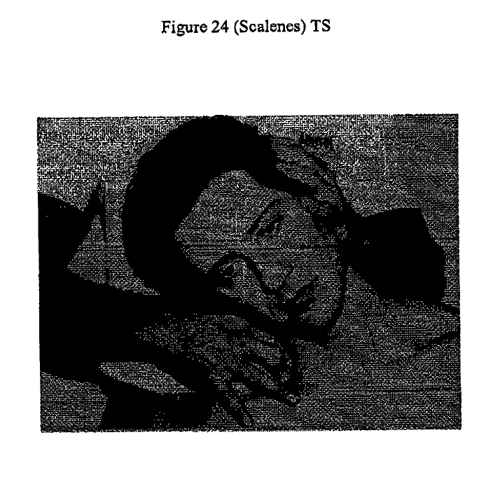

A strengthening protocol of the Scalenes is provided in FIGS. 23 and 24 and is further described as provided below:

| | |
|---|---|
| Patient | Seated. The head is laterally flexed toward the involved side and contralaterally |
| Position: | rotated, |
| Health | Standing behind the patient, with the support hand placed against the side of the |
| practitioner | mandible. The thumb or finger of the contact hand is placed on the application |
| Position: | point. |
| Application | LI-17: On the anterior lateral aspect of the neck, superior to the midpoint of the |
| Point | supraclavicular fossa, on the posterior border of the SCM muscle. |
| Location: | SI-16: On the lateral aspect of the neck, on the posterior border of the SCM |
| | muscle. |
| | ST-12: At the midpoint of the supraclavicular fossa, 4” lateral to the median |
| | line. |
| Procedure: | The patient laterally translates the head away from the application point and |
| | ipsilaterally rotates the head. To do so, the patient must press the jaw or lower |
| | part of the head laterally without initiating the movement from the top of the |
| | head. The Health practitioner resists but allows nearly full range of motion. |
| | Repeat the procedure, if necessary, no more than 3 times per application point. |
| | NB: This procedure may also be done in the supine position. |
| Attachments: | O: Posterior tubercle of TVP of C3 to C6 |
| (Anterior) | I: Scalene tubercie on 1^{st} rib |
| Attachments: | O: Posterior Tubercle Of TVP Of C2 To C7 |
| (Medius) | I: Upper surface of 1^{st} rib |
| Action: | Cervical (unilaterally): Contralateral rotation, lateral flexion |
| (Anterior/ | |
| Medius) | |
| | Cervical (bilaterally): Flexion (weak) |
| | Rib: Elevation of the 1^{st} rib in inspiration. |

### EXAMPLE 16

### Lengthening Protocol of The Temporalis

A lengthening protocol of the Temporalis is provided in FIGS. 23 and 25 and is further described as provided below:

| | |
|---|---|
| Patient | Supine. The Patient's Head Is Contralaterally Flexed And Rotated Away From |
| Position: | The Involved Side. |
| Health | 2 possible positions: |
| practitioner | |
| Position(s): | |
| | 1) Sitting or standing at the head of the table, facing the patient. The |
| | support hand is placed on the superior aspect of the shoulder. The |
| | fingertips of the contact hand are placed on the application point and the |
| | forearm of the contact hand is placed across the lateral aspect of the |
| | patient's head. |
| | 2) Sitting at the head of the table. The left and right arms cross with the left |
| | hand over the right pushing down the right shoulder and the right |
| | forearm pushing the head to the left shoulder. The right hand cradles the |
| | back of the neck with the thumb applying PDA to the application point. |
| | (Picture not shown) |
| Application | LI-17: On the anterior lateral aspect of the neck, superior to the midpoint of the |
| Point | supraclavicular fossa, on the posterior border of the SCM muscle. |
| Locations: | SI-16: On the lateral aspect of the neck, on the posterior border of the SCM |
| | muscle. |
| Procedure: | a) The patient raises the shoulder on the involved side and ipsilaterally |
| | flexes the head/or pushes the head into the direction of resistance. The |
| | Health practitioner resists the movement, allowing for some motion. |
| | b) As the patient relaxes, the Health practitioner presses the shoulder |
| | inferiorly. The rotation may also be increased using the forearm of the |
| | contact hand. |
| | c) Repeat the procedure, if necessary, no more than 3 times per application |
| | point. |
| Attachments: | O: Posterior tubercle of TVP of C2 to C7 |
| (Medius) | I: Upper surface of 1^{st} rib |
| Action: | Cervical (unilaterally); Contralateral rotation, lateral flexion |
| | Cervical (bilaterally): Flexion (weak) |
| | Rib: Elevation of the 1^{st} rib in inspiration. |
| NOTE: | With Health practitioner position 2, the procedure is performed with the Health |
| | practitioner reversing their contact hands. In this case the left forearm resists |
| | head rotation while simultaneously holding the shoulder down. This frees the |
| | right hand to more effectively apply PDA, from underneath, to the Application |
| | Point with the thumb. |

### EXAMPLE 17

### Strengthening Protocol of The Splenius Capitis

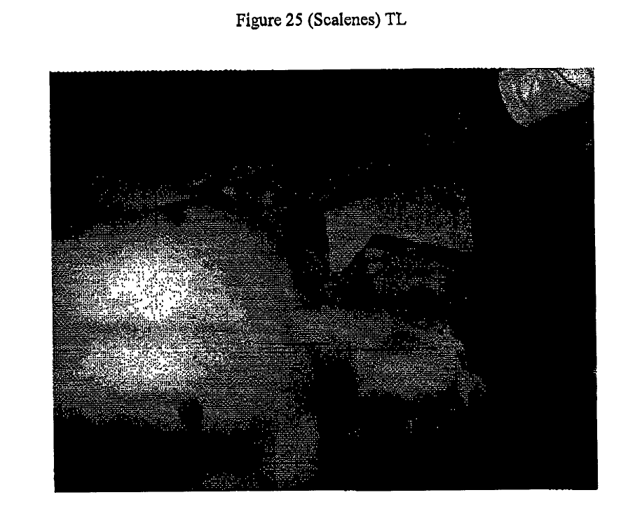

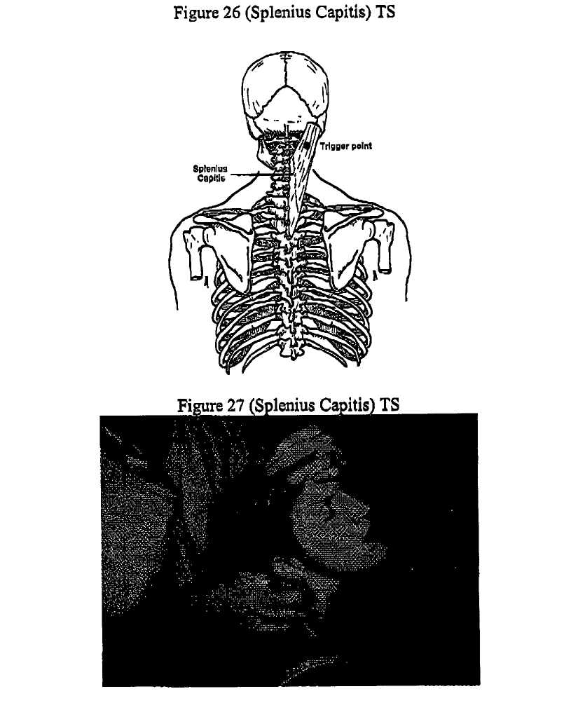

A strengthening protocol of the Splenius Capitis is provided in FIGS. 26 and 27 and is further described as provided below:

| | |
|---|---|
| Patient | Seated, The neck is in neutral. for optimum muscular approximation, the head |
| Position: | may also be simultaneously laterally flexed and slightly extended with |
| | ipsilateral head rotation. |
| Health | Standing behind patient while supporting them with the leg and knee up on the |
| practitioner | table behind their back. The third finger contacts the application point. The |
| Position: | support hand cradles the forehead. |
| Application | Trigger Point (Splenius Capitis): Located just distal to the proximal insertion of |
| Point | the muscle. |
| Locations: | |
| Procedure: | Initially, the patient gently pushes the head forward, leading with the chin to |
| | translate the head anteriorly. (Instruct the patient to lead with the chin.) The |
| | patient then gently rotates away from the involved side to about 45 degrees past |
| | midline. The Health practitioner applies PDA to the application point in a |
| | direction transverse to the muscle fibres and allows motion in a steady and |
| | gradual manner. Repeat the procedure, if necessary, no more than 3 times per |
| | application point. |
| Attachments: | O: SP of C7 to T3, inferior half of ligamentum nuchae |
| (Splenius | I: Mastoid process and lateral third of the superior nuchal line |
| Capitis) | |
| Actions: | Unilaterally: Lateral flexion and ispilateral neck rotation |
| (Splenius | Bilaterally: Extension of the head and neck. |
| Capitits) | |
| NOTE: | 1) If the area is particularly tight, it may be helpful to follow up with an |
| | adjunctive Trigenics lengthening procedure. Also although Trigenics to |
| | this area may create some discomfort during the procedure the patient |
| | should notice significant relief of symptoms afterwards. It is important to |
| | remember not to initiate PDA until the patient engages movement to |
| | prevent a premature increase in pain. |
| | 2) This procedure is also commonly performed in the SUPINE position. |

### EXAMPLE 18

### Lengthening Protocol of The Splenius Capitis

A lengthening protocol of the Splenius Capitis is provided in FIGS. 26 and 28 and is further described as provided below:

| | |
|---|---|
| Patient | Seated. The head is flexed forward and laterally away from the affected side. |
| Position: | |
| Health | Standing behind the patient. The support hand is placed on the back of the |
| practitioner | patient's head, behind the ear on the involved side. The index finger of the contact |
| Position: | hand is placed on the application point. |
| Application | Trigger Point (Splenius Capitis): Located just distal to the proximal insertion of |
| Point | the muscle. |
| Location: | |
| Procedure: | a) The patient extends the neck towards the Health practitioner's contact hand. |
| | The Health practitioner resists the movement while pressing on the |
| | application point. |
| | b) The patient relaxes and the Health practitioner stretches the neck in the |
| | flexed and laterally flexed position. |
| | c) Repeat the procedure, if necessary, no more than 3 times per application |
| | point. |
| Attachments: | O: SP of C7 to T3, inferior half of ligamentum nuchae |
| (Splenius cap) | I: Mastoid process and lateral third of the superior nuchal line |
| Actions: | Unilaterally: Lateral flexion and ispilateral neck rotation |
| (Splenius cap) | Bilaterally: Extension of the head and neck. |

### EXAMPLE 19

### Strengthening Protocol of The Sternocleidomastoid

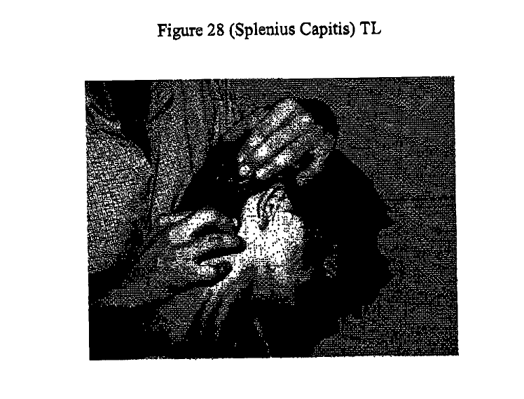

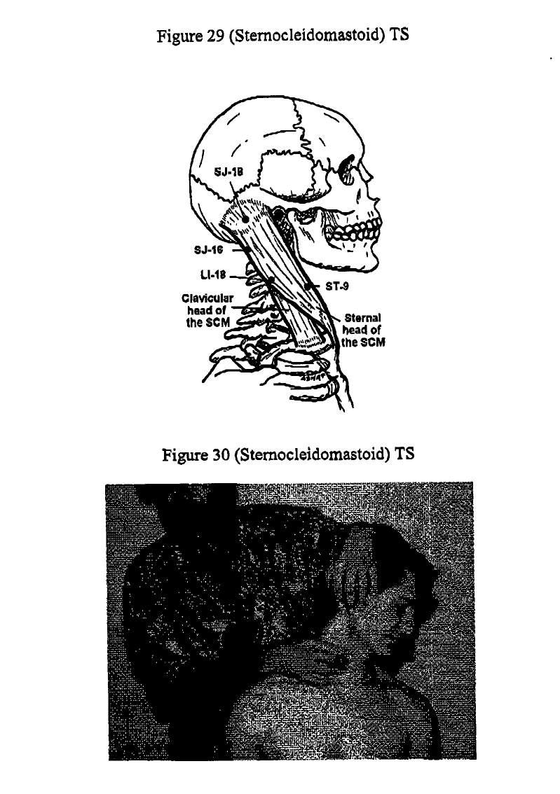

A strengthening protocol of the Sternocleidomastoid is provided in FIGS. 29 and 30 and is further described as provided below:

| | |
|---|---|
| Patient | Seated. The head is flexed forward 30° and is rotated away from the involved |
| Position: | side. |
| Health | Standing behind the patient. The support hand is placed on the back of the |
| practitioner | patient's head, superior and posterior to the ear ipsilateral to the involved side. |
| Position: | The contact hand is placed on the application point. |
| Application | LI-18: On the lateral aspect of the neck, at the level of the Adam's apple, |
| Point | between the sternal head and clavicular head of the sternocleidomastoid muscle |
| Locations: | (SCM). |
| | SJ-16: Posterior and inferior to the mastoid process, on the posterior border of |
| | the SCM muscle. |
| | SJ-18: In the center of the mastoid process. |
| | ST-9*: Level with the tip of the Adam's apple, on the course of the common |
| | carotid artery, at the anterior border of the SCM muscle. |
| | ST-11: At the superior border of the sternal end of the clavicle, between the |
| | sternal head and clavicular head of the SCM. |
| | TP1 Sternal division (superficial) comprised of lower, mid, and upper trigger |
| | points from origin to insertion of the muscle. |
| | TP2 Clavicular Division (deep) comprised of mid level and upper TP. |
| TrP pain | The lower TP refers pain downward over the upper portion of the sternum. The |
| referral: | mid TP refers pain across the cheek, into the maxilla, and encircling the orbit. |
| | The mid-level TP refers pain into the frontal region of the scull (forehead). The |
| | upper division refers pain deep into the ear and posterior auricular area. |
| | The upper division refers pain to the occipital ridge behind the ear and into the |
| | vertex of the scull. |
| | Note: Symptoms may include excessive lacrimation, reddening of the eyes, |
| | ptosis, visual disturbances, tinnitus, and sinus congestion. Symptoms may |
| | include dizziness, vertigo, and ataxia. |
| Procedures: | 1) The patient gently rotates the head toward the application point and |
| | extends the neck slightly. The Health practitioner provides slight |
| | resistance and allows the patient to rotate the head into the application |
| | point. |
| | 2) A second variation of this procedure is also commonly used with the |
| | patient supine. The Health practitioner uses both hands with knife edge |
| | contact applied to the application point. 1Head rotation is resisted |
| | slightly with the Health practitioners left forearm |
| | 3) Repeat the procedure, if necessary, no more than 3 times per application |
| | point. |
| Attachments: | O: Manubrium, sternum and medial 1/3 of clavicle |
| | I: Mastoid process and lateral ½ of superior nuchal line. |
| Action: | Cervical (unilaterally): Contralateral rotation, ipsilateral lateral flexion. |
| | Cervical (bilaterally): Flexion. |
| CAUTION:* | Avoid the carotid artery. |

### EXAMPLE 20

### Lengthening Protocol of The Sternocleidomastoid

A lengthening protocol of the Sternocleidomastoid is provided in FIGS. 29 and 31 and is further described as provided below:

| | |
|---|---|
| Patient | Seated. The neck is flexed slightly. |
| Position: | |
| Health | Seated at the head of the table. The support hand is placed on the patient's head, |
| practitioner | superior and lateral to the eye contralateral to the involved side. The 2^{nd} finger |
| Position: | of the contact hand is placed on the application point. |
| Application | LI-18: On the lateral aspect of the neck, at the level of the Adam's apple, |
| Point | between the sternal head and clavicular head of the sternocleidomastoid muscle |
| Locations: | (SCM). |
| | SJ-16: Posterior and inferior to the mastoid process, on the posterior border of |
| | the SCM muscle. |
| | SJ-18: In the center of the mastoid process. |
| | ST-9*: Level with the tip of the Adam's apple, on the course of the common |
| | carotid artery, at the anterior border of the SCM muscle. |
| | ST-11: At the superior border of the sternal end of the clavicle, between the |
| | sternal head and clavicular head of the SCM. |
| | TP1 Sternal division (superficial) comprised of lower, mid, and upper trigger |
| | points from origin to insertion of the muscle. |
| | TP2 Clavicular division (deep) comprised of mid level and upper TP. |
| Procedure: | The patient attempts to flex and rotate the head away from the involved side. |
| | Health practitioner does not allow any movement. When the patient relaxes, the |
| | Health practitioner rotates the patient's head toward the involved side with |
| | slight extension. Repeat the procedure, if necessary, no more than 3 times per |
| | application point. |
| Attachments: | O: Manubrium sterni and medial ⅓ of clavicle |
| | I: Mastoid process and lateral ½ of superior nuchal line. |
| Action: | Cervical (unilaterally): Contralateral rotation, lateral flexion. |
| | Cervical (bilaterally): Flexion. |
| NOTE: | This procedure is also very good for torticollis. perform it bilaterally. |
| CAUTION:* | Avoid the carotid artery. |

### EXAMPLE 21

### Strengthening Protocol of The Pectorlais Major

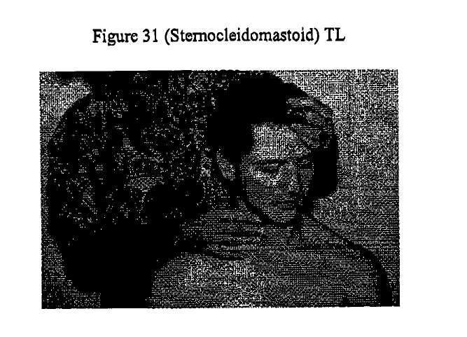

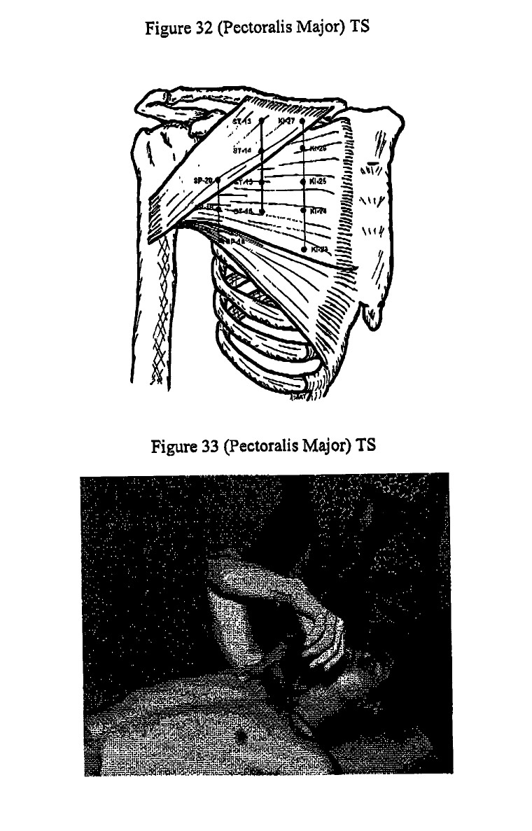

A strengthening protocol of the Pectorlais Major is provided in FIGS. 32 and 33 and is further described as provided below:

| | |
|---|---|
| Patient | Supine. The involved arm is abducted to 90° and externally rotated, |
| Position: | |
| Health | Standing at the head of the patient. The Health practitioner's hand on the same |
| practitioner | side as the patient's involved arm supports the patient's involved elbow. The |
| Position: | Health practitioner's contact thumb/fingers contact the application point. |
| Application | KI-23: In the 4^{th} intercostal space, 2″ lateral to the midline. |
| Point | KI-24: In the 3^{rd} intercostal space, 2″ lateral to the midline. |
| Locations: | KI-25: In the 2^{nd} intercostal space, 2″ lateral to the midline. |
| | KI-26: In the 1^{st} intercostal space, 2″ lateral to the midline. |
| | KI-27: In the depression on the lower border of the medial head of the clavicle, |
| | 2″ lateral to the midline of the sternum. |
| | SP-18: 2″ lateral to the nipple, in the 4^{th} intercostal space. |
| | SP-19: Above SP-18, in the 3^{rd} intercostal space, 6″ lateral to the midline. |
| | SP-20: Above SP-19, below LU-1 in the 2^{nd} intercostal space, 6″ lateral to the |
| | midline. |
| | ST-13*: At the lower border of the middle of the clavicle, on the mamillary line. |
| | ST-14: In the 1^{st} intercostal space, on the mamillary line. |
| | ST-15: In the 2^{nd} intercostal space, on the mamillary line. |
| | ST-16: In the 3^{rd} intercostal space, on the mamillary line. |
| | TP1: Located along the belly of the clavicular division of the muscle. |
| | TP2: Located in the mid belly of the sternal portion of the muscle |
| | TP3: Located in the costal division of the muscle over the angle of the 5^{th} and |
| | 6^{th} rib. |
| | TP4: Located midway between the sternal margin and the nipple line in the |
| | area between the 5^{th} and 6^{th} rib (cardiac arrhythmia TP). |
| TrP pain | TP1: Refers pain locally over the anterior deltoid muscle with some spill over |
| referral: | into the pectoralis muscle itself. |
| | TP2: Refers intense pain over the entire pectoralis muscle, proximal ventral |
| | forearm (essential pattern) and along the anterior deltoid and medial arm and |
| | ulnar side of the hand (spillover pattern). |
| | TP3: Refers pain over the pectoralis muscle inferiorly (essential pattern) and |
| | in and around the axilla (spillover pattern). This may be a cause of breast |
| | tenderness and nipple hypersensitivity more common in women but seen also in |
| | men. |
| | TP4: When active in the left pec muscle it will refer pain to the chest similar |
| | to that of chest pain caused by an acute myocardial infarction. |
| | Note: Trigger points in the pectoralis muscle are often associated with postural |
| | abnormalities (rounded shoulder with a stooped over posture). |
| Procedure: | The patient horizontally abducts the arm while keeping the elbow flexed Repeat |
| | the procedure, if necessary, no more than 3 times per application point.. |
| Attachments: | O: Superior head: Medial ½ of clavicle |
| | Middle head: Manubrium, sternum |
| | Inferior head: Upper six costal cartilages |
| | I: Lateral lip of the intertubercular groove of the humerus |
| Action: | Shoulder: Horizontal adduction, medial rotation |
| | Superior head: Medial rotation, flexion |
| | Middle head: depression of the arm and shoulder |
| | Inferior head: Extension of the arm when it is flexed |
| Muscle | Upper fibers: |
| testing: | Patient is supine. The shoulder is flexed to 90 degrees and horizontally adducted |
| | towards the sternal end of the clavicle with slight medial rotation. Elbow is fully |
| | extended. Doctor stabilizes the patient's opposite shoulder with one hand and |
| | applies pressure against the forearm in the direction of horizontal abduction with |
| | the other hand. |
| | Lower fibers: |
| | Patient is positioned same as above with the exception of the arm being in |
| | horizontal adduction towards the opposite ASIS. The doctor stabilizes the |
| | opposite pelvis with one hand and applies pressure against patient's forearm |
| | with the other hand in the direction of horizontal abduction in an oblique |
| | orientation both superiorly and laterally. |
| NOTE: | 1) This procedure may work better with certain patients if the arm is also |
| | internally rotated 90°. This further decreases tension of the pectoralis |
| | major during the procedure. |
| | 2) ST-13 and CV-20** are used in conjunctively to treat pain in the ribs. |
| | 3) **CV-20 is located on the anterior midline, at the level of the 1^{st} |
| | intercostal space. |
| | 4) Contracture or shortness of this muscle will result in rounded shoulders |
| | (medial rotation and adduction of the humerus.) |

### EXAMPLE 22

### Lengthening Protocol of The Pectorlais Major

A lengthening protocol of the Pectorlais Major is provided in FIGS. 32 and 34 and is further described as provided below:

| | |
|---|---|
| Patient | Supine. The involved arm in flexed to 90 degrees, and externally rotated with the |
| Position: | elbow flexed to 45 degrees. (A second start position is with the elbow straight.) |
| Health | At the head of the table on the involved side in a fencer stance. The arm closest |
| practitioner | to the patient contacts the application point. The other hand stabilizes the |
| Position: | patient's arm and resists any movements. |
| Application | KI-23: In the 4^{th} intercostal space, 2″ lateral to the midline. |
| Point | KI-24: In the 3^{rd} intercostal space, 2″ lateral to the midline. |
| Locations: | KI-25: In the 2^{nd} intercostal space, 2″ lateral to the midline. |
| | KI-26: In the 1^{st} intercostal space, 2″ lateral to the midline. |
| | KI-27: In the depression on the lower border of the medial head of the clavicle, |
| | 2″ lateral to the midline of the sternum. |
| | SP-18: 2″ lateral to the nipple, in the 4^{th} intercostal space. |
| | SP-19: Above SP-18, in the 3^{rd} intercostal space, 6″ lateral to the midline. |
| | SP-20: Above SP-19, below LU-1 in the 2^{nd} intercostal space, 6″ lateral to the |
| | midline. |
| | ST-13*: At the lower border of the middle of the clavicle, on the mamillary line. |
| | ST-14: In the 1^{st} intercostal space, on the mamillary line. |
| | ST-15: In the 2^{nd} intercostal space, on the mamillary line. |
| | ST-16: In the 3^{rd} intercostal space, on the mamillary line. |
| | TP1: Located along the belly of the clavicular division of the muscle. |
| | TP2: Located in the mid belly of the sternal portion of the muscle |
| | TP3: Located in the costal division of the muscle over the angle of the 5^{th} and |
| | 6^{th} rib. |
| | TP4: Located midway between the sternal margin and the nipple line in the |
| | area between the 5^{th} and 6^{th} rib (cardiac arrhythmia TP). |
| TrP pain | TP1: Refers pain locally over the anterior deltoid muscle with some spill over |
| referral: | into the pectoralis muscle itself. |
| | TP2: Refers intense pain over the entire pectoralis muscle, proximal ventral |
| | forearm (essential pattern) and along the anterior deltoid and medial arm and |
| | ulnar side of the hand (spillover pattern). |
| | TP3: Refers pain over the pectoralis muscle inferiorly (essential pattern) and |
| | in and around the axilla (spillover pattern). This may be a cause of breast |
| | tenderness and nipple hypersensitivity more common in women but seen also in |
| | men. |
| | TP4: When active in the left pec muscle it will refer pain to the chest similar |
| | to that of chest pain caused by an acute myocardial infarction. |
| | Note: Trigger points in the pectoralis muscle are often associated with postural |
| | abnormalities (rounded shoulder with a stooped over posture). |
| Procedure: | 1) Upper head (clavicular portion): Patient attempts to flex and horizontally |
| | adduct the arm. |
| | 2) Middle head (sternal portion): Patient attempts to horizontally adduct the |
| | arm. |
| | 3) Inferior head (costal portion): Patient attempts to extend and horizontally |
| | adduct the arm. |
| | Repeat the procedure, if necessary, no more than 3 times per application point. |
| | Note: With all three procedures the Health practitioner will resist the action |
| | and allow for moderate movement. This procedure may also be done sitting with |
| | the Health practitioner standing behind the patient on the involved side. |
| Attachments: | O: Superior head: Medial ½ of clavicle |
| | Middle head: Manubrium, sternum |
| | Inferior head: Upper six costal cartilages |
| | I: Lateral lip of the intertubercular groove of the humerus |
| Action: | Shoulder: Horizontal adduction, medial rotation |
| | Superior head: Medial rotation, flexion |
| | Middle head: Depression of the arm and shoulder |
| | Inferior head: Extension of the arm when it is flexed |
| Muscle | Upper fibers: |
| Testing: | Patient is supine. The shoulder is flexed to 90 degrees and horizontally adducted |
| | towards the sternal end of the clavicle with slight medial rotation. Elbow is fully |
| | extended. Doctor stabilizes the patient's opposite shoulder with one hand and |
| | applies pressure against the forearm in the direction of horizontal abduction with |
| | the other hand. |
| | Lower fibers: |
| | Patient is positioned same as above with the exception of the arm being in |
| | horizontal adduction towards the opposite ASIS. The doctor stabilizes the |
| | opposite pelvis with one hand and applies pressure against patient's forearm |
| | with the other hand in the direction of horizontal abduction in an oblique |
| | orientation both superiorly and laterally. |

### EXAMPLE 23

### Strengthening Protocol of The Intercostals

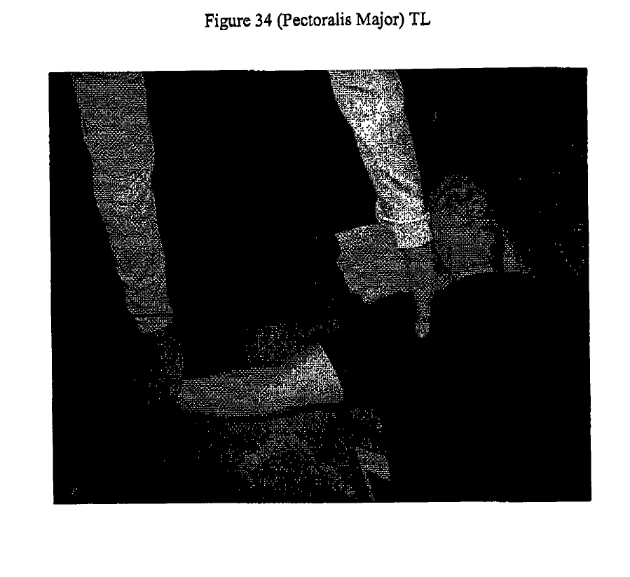

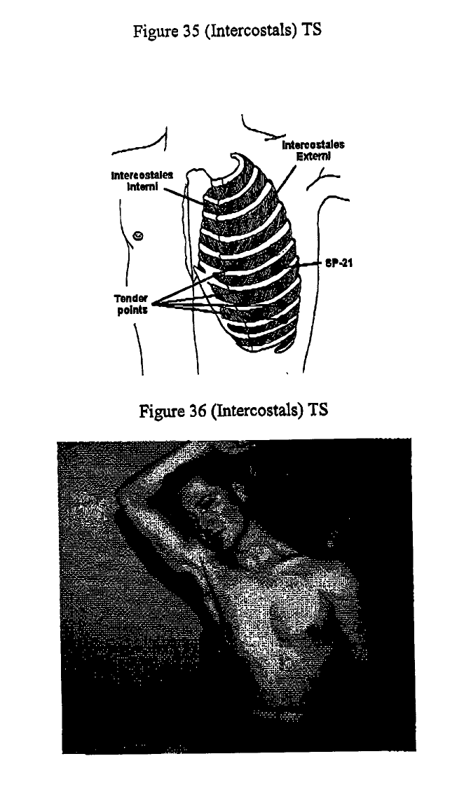

A strengthening protocol of the Intercostals is provided in FIGS. 35 and 36 and is further described as provided below:

| Patient | Sitting straddling the table. The arm of the involved side is placed over the head. | |
|---|---|---|
| Position: | The elbow is flexed so that the forearm is resting on the top of the patient's head. | |
| | The patient laterally flexes toward the involved side. | |
| Health | Sitting behind the patient. The 2^{nd}, 3^{rd}, and 4^{th} fingers of the contact hand in the | |
| practitioner | intercostal space (Application Point). The support arm is laid across the | |
| Position: | shoulders behind the patient's head, with an arch of the wrist to permit normal | |
| | carriage of the patient's head. | |
| Application | SP-21: On the mid-axillary line, 6″ below the axilla, midway between the axilla | |
| Point | and the free end of the 11^{th} rib. | |
| Locations: | Tender points: They are located on the lateral aspect from the 5^{th} intercostal | |
| | space to 10^{th} intercostal space. | |
| Procedure: | PDA is applied with the distal IP joints of the index and 3^{rd} fingers while the | |
| | patient laterally flexes away from the involved side and rotates the left shoulder | |
| | backward slightly at the end point. The Health practitioner resists the flexion | |
| | with the hand of the supporting arm. Repeat the procedure, if necessary, no more | |
| | than 3 times per application point. | |
| Attachments: | External intercostals | Internal intercostals |
| | O: Inferior border of rib above | O: Superior border of rib below |
| | I: Superior border of rib below | I: Inferior border of rib above |

| | |
|---|---|
| Action: | External intercostals: Ribs elevation during inspiration |
| | Internal intercostals: Ribs depression during expiration. |

### EXAMPLE 24

### Lengthening Protocol of The Intercostals

A lengthening protocol of the intercostals is provided in FIGS. 35 and 37 and is further described as provided below:

| Patient | Sitting straddling the table with the arm of the involved side above the head. | |
|---|---|---|
| Position: | The elbow is flexed so that the forearm is resting on the top of the patient's | |
| | head. The patient laterally flexes away from the involved side. | |
| Health | Sitting behind the patient. The 2^{nd}, 3^{rd}, and 4^{th} fingers of the contact hand in the | |
| practitioner | intercostal space (Application Point). The support arm holds the patient's distal | |
| Position: | aspect of the humerus. | |
| Application | SP-21: On the mid-axillary line, 6″ below the axilla, midway between the axilla | |
| Point | and the free end of the 11^{th} rib. | |
| Locations: | Tender points: They are located on the lateral aspect from the 5^{th} intercostal | |
| | space to 10^{th} intercostal space. | |
| Procedure: | a) The patient attempts to bend toward the involved side. The Health | |
| | practitioner resists the movement using the patient's elbow. The Health | |
| | practitioner applies pressure along the intercostal space, moving | |
| | anteriorly with either the index and 3^{rd} fingers or the thumb. | |
| | b) When the patient relaxes, the Health practitioner increases the stretch | |
| | away from the involved side. | |
| | c) Repeat the procedure, if necessary, no more than 3 times per application | |
| | point. | |
| Attachments: | External intercostals | Internal intercostals |
| | O: Inferior border of rib above | O: Superior border of rib below |
| | I: Superior border of rib below | I: Inferior border of rib above |

| | |
|---|---|
| Action: | External intercostals: Ribs elevation during inspiration |
| | Internal intercostals: Ribs depression during expiration. |

### EXAMPLE 25

### Strengthening Protocol of The Diaphragm and Rectus Abdominis

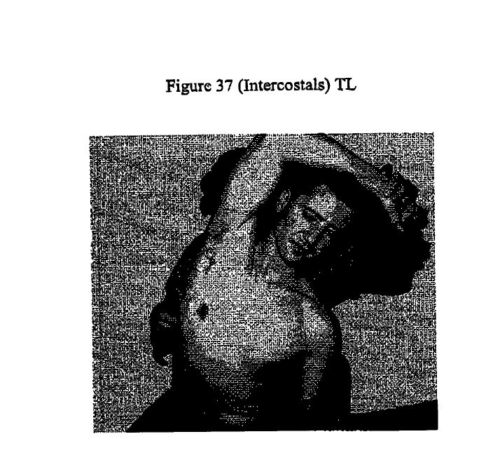

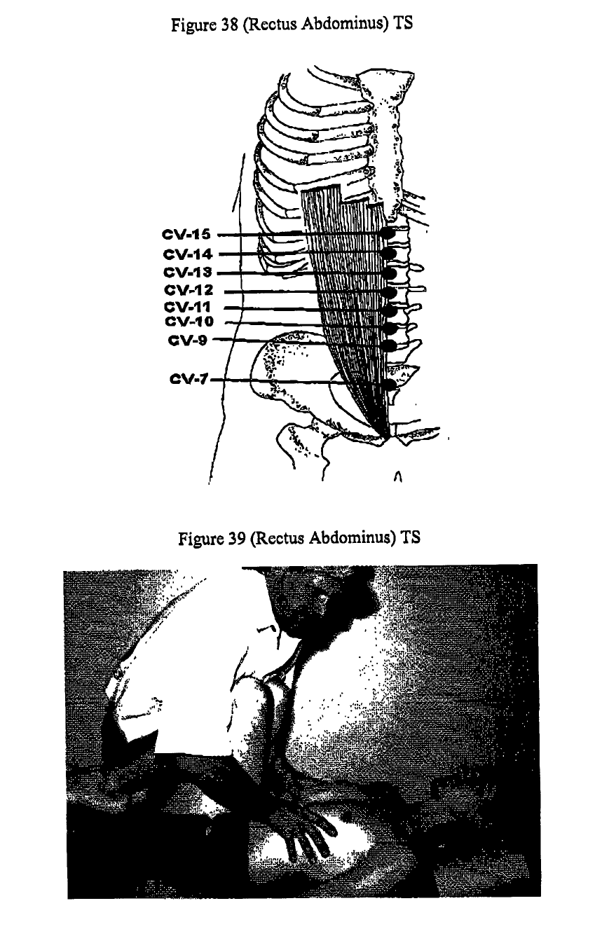

A strengthening protocol of the diaphragm and rectus abdominis is provided in FIGS. 38 and 39 and is further described as provided below:

| | |
|---|---|
| Patient | Supine. Both knees are drawn near the chest. |
| Position: | |
| Health | Standing at the side of the patient. Either the thumbs or the flats the fingers of |
| practitioner | both hands are placed on the Application Point. The Health practitioner's chest is |
| Position: | in contact with the patient's shins. The pressure applied should be on an angle, |
| | NOT straight down. |
| Application | CV-7: On the anterior midline, 1″ below the umbilicus. |
| Point | CV-9: On the anterior midline, 1″ above the umbilicus. |
| Locations: | CV-10: On the anterior midline, 2″ above the umbilicus. |
| | CV-11: On the anterior midline, 3″ above the umbilicus. |
| | CV-12: On the anterior midline, 4″ above the umbilicus. |
| | CV-13: On the anterior midline, 5″ above the umbilicus. |
| | CV-14: On the anterior midline, 6″ above the umbilicus. |
| Procedure: | a) The patient gently extends the hips, pressing the legs against the Health |
| | practitioner's chest. The Health practitioner allows very little movement, |
| | and GENTLY presses on the Application Point. |
| | The Health practitioner can progress along the costal margin when treating the |
| | diaphragm, or straight down along the linea alba. |
| | b) Repeat the procedure, if necessary, no more than 3 times per application |
| | point. |
| Attachments: | O: Pubic crest and pubic symphysis |
| (Rectus) | |
| Abdominis | I: Xiphoid process and costal cartilages 5-7 |
| Action: | Ribs: Depression |
| | Truck: Flexion |
| | Pelvis: Posterior tilt |
| CAUTION: | 1) If the Health practitioner feels a strong pulsing sensation, it is the |
| | abdominal aorta. The Health practitioner should release the pressure and |
| | move to either side. |
| | 2) CV-10 meridian point may be contraindicated in cases of pregnancy. |

### EXAMPLE 26

### Strengthening Protocol of The Upper Trapezius

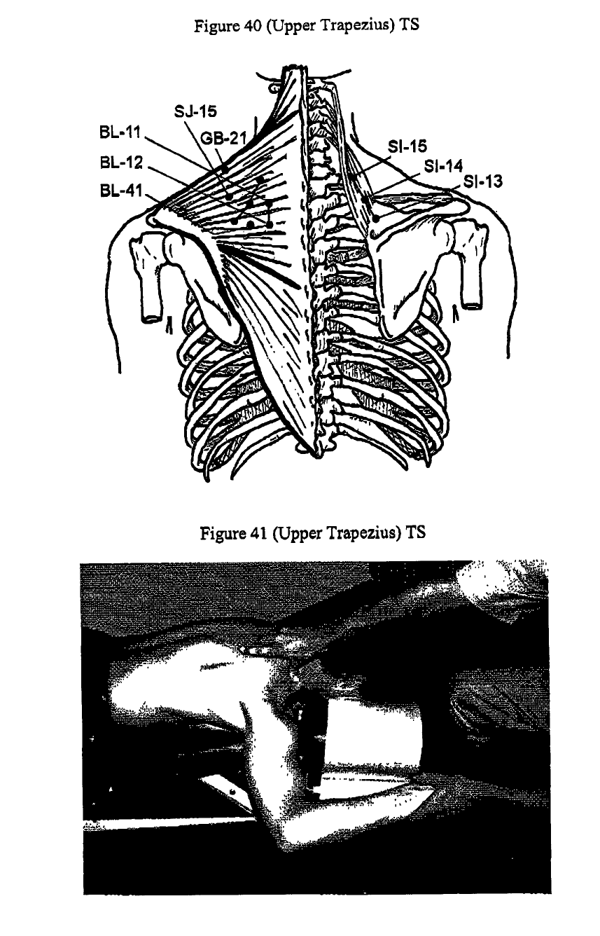

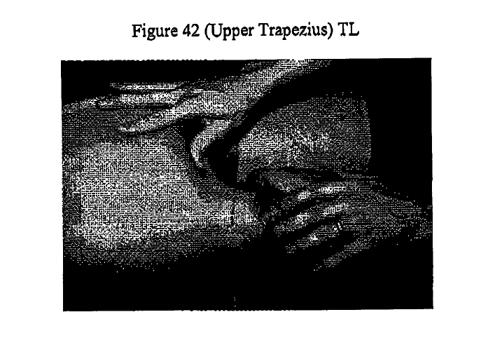

A strengthening protocol of the Upper Trapezius is provided in FIGS. 40 and 41 and is further described as provided below:

| | |
|---|---|
| Patient | Prone. The head is rolled from the midline so that it is facing away from the |
| Position: | involved side and slightly extended. |
| Health | Standing or sitting at the head of the table. The support hand is placed on the |
| practitioner | head behind the ear. The contact hand is placed on the Application Point at the |
| Position: | superior pole of the scapula. (The hands may be reversed if the Health |
| | practitioner stands facing cephalad at the involved side of the patient.) |
| Application | SI-13: At the medial border of the suprascapular fossa, about midway between |
| Point | glenoid fossa and the spinous process of the 2^{nd} thoracic vertebra. |
| Locations: | SI-14: 3″ lateral to the lower border of the spinous process of the 1^{st} thoracic |
| | vertebra, on the line that indicates the medial border of the scapula. |
| | SI-15: 2″ lateral to the lower border of the spinous process of C7. |
| | GB-21: Midway between C7 and acromioclavicular joint, at the highest point of |
| | the shoulder |
| | SJ-15: On the superior angle of the scapula. |
| | BL-11: 1.5″ lateral to the lower border of the spinous process of T1. |
| | BL-12: 1.5″ lateral to the lower border of the spinous process of T2. |
| | BL-41: 3″ lateral to the lower border of the spinous process of the T2, just |
| | medial to the vertebral border of the scapula. |
| Procedure: | The patient rolls the head back towards neutral. As the muscle begins to relax, |
| | the contact thumb should goes anteriorly towards the clavicle, then inferiorly. |
| | Repeat the procedure, if necessary, no more than 3 times per application point. |
| Attachments: | O: External occipital protuberance, medial 1/3 of superior nuchal line |
| | ligamentum nuchae and spinous process of the C6. |
| | I: Lateral 1/3 of clavicle and acromion process |
| Action: | Scapula: elevation and rotation of the glenoid fossa cranially. |
| (Upper | |
| Trapezius) | Shoulder: elevation |
| | Cervical (unilaterally): lateral flexion; contralateral rotation |
| | Cervical (bilaterally): extension |
| Muscle | Patient is seated with the shoulder elevated. The head is slightly rotated away |
| Testing: | from the involved side with slight extension and lateral flexion towards the |
| | elevated shoulder. Doctor places one hand on the elevated shoulder. The other |
| | hand stabilizes the head by placing the hand on the back of the patient's head |
| | facing the elevated shoulder. Doctor applies pressure in the direction of |
| | depression on the shoulder with one hand and in the direction of flexion |
| | anteriolaterally on the head. |
| NOTE: | This procedure can also be used for levator scapula when the patient begins with |
| | the head in ipsilateral rotation and rotates the head towards the neutral position. |

### EXAMPLE 27

### Lengthening Protocol Of The Upper Trapezius

A lengthening protocol of the Upper Trapezius is provided in FIGS. 40 and 42 and is further described as provided below:

| | |
|---|---|
| Patient | Prone. The head is rolled from the midline so that the patient is facing the |
| Position: | involved side. |
| Health | Standing or sitting at the head of the table. The support hand is placed on the |
| practitioner | involved side of the head behind the ear which is facing up. The contact hand |
| Position: | is placed on the Application Point at the superior pole of the scapula. |
| Application | SI-13: At the medial border of the suprascapular fossa, about midway between |
| Point | glenoid fossa and the spinous process of the 2^{nd} thoracic vertebra. |
| Locations: | SI-14: 3″ lateral to the lower border of the spinous process of the 1^{st} thoracic |
| | vertebra, on the line that indicates the medial border of the scapula. |
| | SI-15: 2″ lateral to the lower border of the spinous process of C7. |
| | GB-21: Midway between C7 and acromioclavicular joint, at the highest point of |
| | the shoulder |
| | SJ-15: On the superior angle of the scapula. |
| | BL-11: 1.5″ lateral to the lower border of the spinous process of T1. |
| | BL-12: 1.5″ lateral to the lower border of the spinous process of T2. |
| | BL-41: 3″ lateral to the lower border of the spinous process of the T2, just |
| | medial to the vertebral border of the scapula. |
| Procedure: | a) The patient attempts to slowly roll the head toward the neutral position. |
| | (contralateral rotation) The Health practitioner resists the patient's |
| | movement but allows minimal movement. (The patient is essentially |
| | pressing their face into the headrest of the table.) |
| | b) When the patient relaxes, the Health practitioner will maintain the |
| | tension and then further elongate the muscle while still contacting the |
| | Application Point. |
| | c) Repeat the procedure, if necessary, no more than 3 times per application |
| | point. |
| Attachments: | O: External occipital protuberance, medial ⅓ of superior nuchal line |
| (Upper | ligamentum nuchae and spinous process of the C6. |
| Trapezius) | I: Lateral ⅓ of clavicle and acromion process |
| Action: | Scapula: elevation and rotation of the glenoid fossa cranially. |
| (Upper | Shoulder: elevation |
| Trapezius) | Cervical (unilaterally): lateral flexion; contralateral rotation |
| | Cervical (bilalterally): extension |
| Muscle | Patient is seated with the shoulder elevated. The head is slightly rotated away |
| Testing: | from the involved side with slight extension and lateral flexion towards the |
| | elevated shoulder. Practitioner places one hand on the elevated shoulder. The |
| | other hand stabilizes the head by placing the hand on the back of the patient's |
| | head facing the elevated shoulder. Practitioner applies pressure in the direction |
| | of depression on the shoulder with one hand and in the direction of flexion |
| | anteriolaterally on the head. |
| NOTE: | This procedure can also be used for Levator Scapula when the patient begins |
| | with the head in contralateral rotation and rotates the head towards the neutral |
| | position. |

### EXAMPLE 28

### Strengthening Protocol of The Sacrospinalis

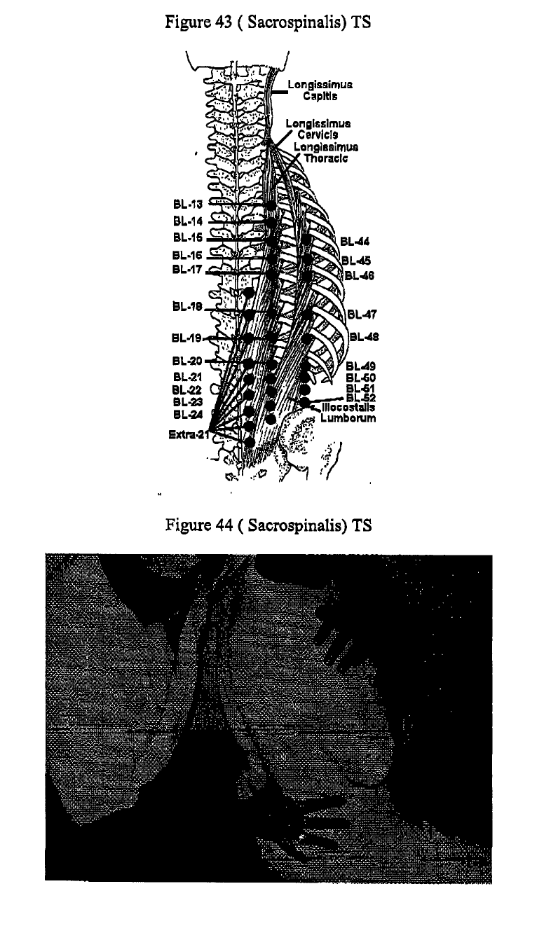

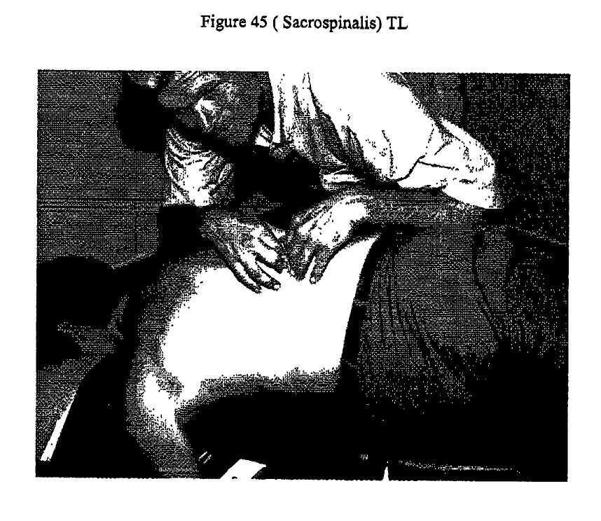

A strengthening protocol of the sacrospinalis is provided in FIGS. 43 and 44 and is further described as provided below:

| | |
|---|---|
| Patient | Seated the back is in slight extension and rotation toward the involved side. |
| Position: | |
| Health | Standing behind the patient. The hand closest to the involved side applies |
| practitioner | pressure to the application point. The opposite arm and hand stabilizes the |
| Position: | patient's upper body. |
| Application | BL-20: 1.5′ lateral to the lower border of the spinous process of T11. |
| Point | BL-21: 1.5″ lateral to the lower border of the spinous process of T12. |
| Locations: | BL-22: 1.5″ lateral to the lower border of the spinous process of L1. |
| | BL-23: 1.5″ lateral to the lower border of the spinous process of L2. |
| | BL-24: 1.5″ lateral to the lower border of the spinous process of L3. |
| | BL-49: 3″ lateral to the lower border of the spinous process of T11. |
| | BL-50: 3″ lateral to the lower border of the spinous process of T12. |
| | BL-51: 3″ lateral to the lower border of the spinous process of L1. |
| | BL-52: 3″ lateral to the lower border of the spinous process of L2. |
| Procedure: | The patient flexes and rotates away from the involved side. The Health |
| | practitioner resists the movement but allows for full range of motion |
| | Repeat the procedure, if necessary, no more than 3 times per application |
| | point. |
| Attachments: | These groups of muscles include Iliocostalis, Longissimus and Spinalis |
| | (see back muscle summary chart for the muscle attachment details). |
| Action: | Unilaterally: lateral flexion, may assist in ipsilateral rotation (spinous |
| | process rotates away). |
| | Bilaterally: extension. |

### EXAMPLE 29

### Lengthening Protocol of The Sacrospinalis

A lengthening protocol of the sacrospinalis is provided in FIGS. 43 and 45 and is further described as provided below:

| | |
|---|---|
| Patient | Prone. The lower part of the body is rotated so that the patient is on the hip |
| Position: | contralateral to the involved side. The legs are crossed behind in a scissor-like |
| | position and are kept as straight as possible. |
| Health | Standing at the patient's waist level on the same side of the patient's involved |
| practitioner | side, facing perpendicular to the table. The forearm toward the patient's head is |
| Position: | placed on the posterior aspect of the patient's shoulder. The forearm towards the |
| | patient's feet is placed in front of the patient's ASIS. |
| Application | Extra 21: These are series of 28 pairs of points situated 0.5″ lateral to the lower |
| Point | ends of the dorsal spines of the C1 to S4. |
| Locations: | BL-20: 1.5″ lateral to the lower border of the spinous process of T11. |
| | BL-21: 1.5″ lateral to the lower border of the spinous process of T12. |
| | BL-22: 1.5″ lateral to the lower border of the spinous process of L1. |
| | BL-23: 1.5″ lateral to the lower border of the spinous process of L2. |
| | BL-24: 1.5″ lateral to the lower border of the spinous process of L3. |
| | BL-49: 3″ lateral to the lower border of the spinous process of T11. |
| | BL-50: 3″ lateral to the lower border of the spinous process of T12. |
| | BL-51: 3″ lateral to the lower border of the spinous process of L1. |
| | BL-52: 3″ lateral to the lower border of the spinous process of L2. |
| Procedure: | a) The patient rotates the shoulder posteriorly and the pelvis anteriorly |
| | against the Health practitioner's resistance |
| | b) When the patient relaxes, the Health practitioner stretches the patient in a |
| | combination of rotation and long axis distraction. |
| | c) Repeat the procedure, if necessary, no more than 3 times per application |
| | point. |
| Attachments: | This group of muscles includes Iliocostalis, Longissimus and Spinalis. (see back |
| | muscle summary chart for the muscle attachment details) |
| Action: | Unilaterally: lateral flexion, may assist in ipsilateral rotation (spinous away) |
| | Bilaterally: extension |
| NOTE: | This procedure can also help to lengthen Quadratus Lumborum. |

### EXAMPLE 30

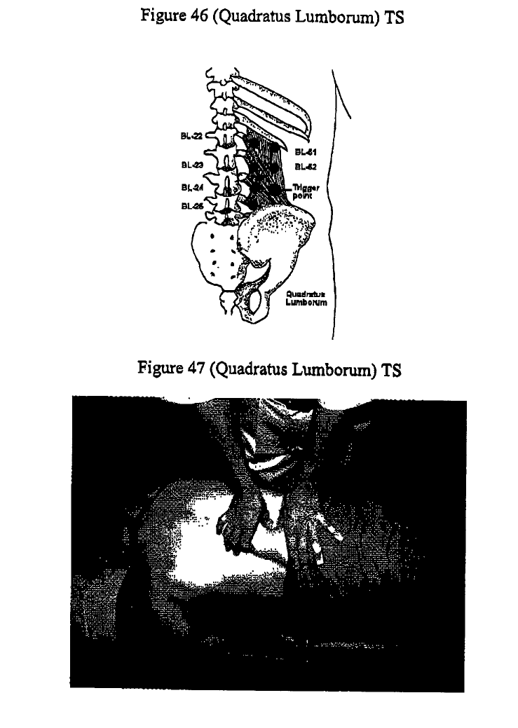

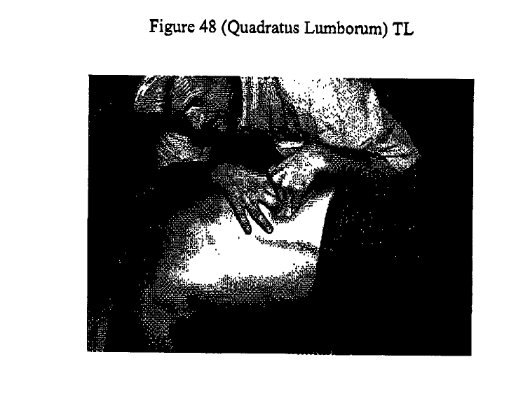

### Strengthening Protocol of The Quadratus Lumborum A strengthening protocol of the quadratus lumborum is provided in FIGS. 46 and 47 and is further described as provided below:

| | |
|---|---|
| Patient | Prone. The lower part of the body is rotated so that the |
| Position: | patient is on the hip contralateral to the involved side. The |
| | legs are crossed behind in a scissor-like position and are |
| | kept as straight as possible. |
| Health | Standing on the patient's involved side, at the level of the |
| practitioner | patient's waist, and facing the table. The Health practitioner |
| Position: | contacts the Application Point with both thumbs. |
| Application | BL-51: 3″ lateral to the lower border of the spinous process |
| Point | of L1. BL-52: 3″ lateral to the lower border of the spinous |
| Locations: | process of L2, |
| Procedure: | The patient pushes the contralateral shoulder towards the |
| | table. The Health practitioner applies PDA to the |
| | Application Point. Repeat the procedure, if necessary, no |
| | more than 3 times per application point. |
| Attachments: | O: TVP of L3 to L5, iliolumbar ligament and iliac crest |
| | I: Lower border of last rib and TVP of L1 to L3 |
| Action: | Depression of 12^{th} rib |
| | Unilaterally: lateral flexion |
| | Bilaterally: extension |
| Muscle | Patient lies on the side with the upper arm extended straight |
| testing: | along the side and the under arm resting on the opposite |
| | shoulder. Patient's legs are straight. The doctor stabilizes |
| | the legs and pelvis while the patient attempts to raise the |
| | trunk sideways. Be sure the patient does not rotate the body |
| | as the patient attempts to raise the trunk. (This tests for |
| | lateral flexion of the trunk. This is not a pure QL muscle |
| | test) |
| | If the patient had strong lateral trunk muscles and strong hip |
| | abductor muscles, the patient would be able to raise the |
| | trunk in lateral flexion with full range of motion. |
| | If the patient had strong lateral trunk muscles and weak hip |
| | abductor muscles, the patient would be able to weakly raise |
| | the trunk and the pelvis would also be drawn upward |
| | towards to head. |
| NOTE: | 1) This procedure is always followed by the Quadratus |
| | Lumborum Trigenics |
| | Lengthening. |
| | 2) If the patient finds this procedure uncomfortable, it may |
| | help to have him drop both hands toward the floor and press |
| | both shoulders into the table during the procedure. |

### EXAMPLE 31

### Lengthening Protocol of The Quadratus Lumborum

A lengthening protocol of the quadratus lumborum is provided in FIGS. 46 and 48 and is further described as provided below:

| | |
|---|---|
| Patient Position: | Prone. The lower part of the body is rotated so that the |
| | patient is on the hip contralateral to the involved side. |
| | The legs are crossed behind in a scissor-like position |
| | and are kept as straight as possible. |
| Health | Standing at the patient's waist level on the same side |
| practitioner | as the patient's involved side, facing perpendicular to |
| Position: | the table. The forearm toward the patient's head is |
| | placed on the posterior aspect of the patient's shoulder, |
| | The forearm towards the patient's feet is placed in the |
| | patient's ASIS. |
| Application Point | O: TVP of L3 to L5, iliolumbar ligament and iliac |
| Locations: | crest I: Lower border of last rib and TVP of L1 to L3 |
| Procedure: | O: TVP of L3 to L5, iliolumbar ligament and iliac |
| | crest I: Lower border of last rib and TVP of L1 to L3 |
| Attachments: | Depression of 12^{th} rib |
| | Unilaterally: lateral flexion |
| | Bilaterally: extension |
| Action: | Depression of 12^{th} rib |
| | Unilaterally: lateral flexion |
| | Bilaterally: extension |
| Muscle testing: | Patient lies on the side with the upper arm extended |
| | straight along the side and the under arm resting on the |
| | opposite shoulder. Patient's legs are straight. The |
| | doctor stabilizes the legs and pelvis while the patient |
| | attempts to raise the trunk sideways. Be sure the |
| | patient does not rotate the body as the patient attempts |
| | to raise the trunk. (This tests for lateral flexion of the |
| | trunk. This is not a pure QL muscle test) |
| | If the patient had strong lateral trunk muscles and |
| | strong hip abductor muscles, the patient would be able |
| | to raise the trunk in lateral flexion with full range of |
| | motion. |
| | If the patient had strong lateral trunk muscles and |
| | weak hip abductor muscles, the patient would be able |
| | to weakly raise the trunk and the pelvis would also be |
| | drawn upward towards to head. |
| NOTE: | The patient can also laterally flex the torso, bringing |
| | the shoulder and the pelvis towards each other. |

### EXAMPLE 32

### Embodiments without a medical or health practitioner.

Aspects of the present invention enable patients to treat themselves. These procedures can be learned by patients and are particularly beneficial to office or factory workers who find they suffer from static loading and cumulative strain disorders. Once having learned the procedures, patients may be able to apply them daily as preventative exercises and/or to attain immediate relief from muscle/tendon related pain.

(a) Upper Shoulders (Trapezius & Levator Scapulae)

In an aspect of the present invention, the patient can practice the treatment protocols without the aid of a medical or health practitioner. For the upper shoulders, the patient crosses the arm opposite the target muscle over to the opposite shoulder and press on the tender or knotted area. The patient may use the 3rd finger supported by the index finger. The patient may use the hand on the side of the target area support the elbow of the opposite arm from underneath. As the patient breathes out, he or she pushes up on the elbow while simultaneously pulling the elbow down and pressing deeply into the tender spot. This can be done for 7 sec. and the patient should feel the hard area of the muscle soften substantially. The patient may also bring the elbow of the side of involvement upward during the application of pressure at the application point and lowers the scapular out of the way to allow for deeper penetration.

(b) Upper Back (Rhomboids, Teres Major)

For the upper back, the patient crosses the opposite arm as far over as possible and contacts the tender areas of the upper back on the opposite side. With middle finger cross the involved side underneath the other arm, the patient grabs the opposite shoulder. The patient pulls both shoulders back while pressing the trigger spot for 7 seconds.

Although the present invention has been described with reference to these preferred aspects, other aspects of the invention can achieve the same results. Variations and modifications of the invention will be apparent to one skilled in the art and the following claims are intended to cover all such variations, modifications and equivalents.

I claim:

1. A method of treating somatic dysfunction of soft tissue or a joint in a human, the method comprising the steps of:
(a) applying reflexogenic neurophysiology to a target site of the human;
(b) stimulating an application point associated with the target site of the human; and
(c) directing the human to relax the soft tissue associated with the target site.

2. The method of claim 1, wherein steps (a), (b) and (c) are conducted simultaneously or concurrently.

3. The method of claim 2, wherein the reflexogenic neurophysiology comprises either a strengthening or a lengthening procedure.

4. The method of claim 3, wherein the strengthening procedure comprises reciprocal inhibition.

5. The method of claim 3, wherein the lengthening procedure comprises the inverse myotatic reflex.

6. Teaching a method of treating somatic dysfunction of soft tissue or a joint in a human to students selected from the group comprising medical practitioners, health practitioners and patients, the method comprising the steps of:
(a) applying reflexogenic neurophysiology to a target site of the human;
(b) stimulating an application point associated with the target site of the human; and
(c) directing the human to relax the soft tissue associated with the target site.

7. Teaching a method as recited in claim 6, wherein steps (a), (b) and (c) are conducted simultaneously or concurrently.

8. Teaching a method as recited in claim 7, wherein the reflexogenic neurophysiology comprises either a strengthening or a lengthening procedure.

9. Teaching a method as recited in claim 8, wherein the strengthening procedure comprises reciprocal inhibition.

10. Teaching a method as recited in claim 8, wherein the lengthening procedure comprises the inverse myotatic reflex.
